(19) United States
(12) Patent Application Publication
(10) Pub. No.: US 2023/0031225 A1
(43) Pub. Date: Feb. 2, 2023

(54) APPARATUS, SYSTEM, AND METHOD OF WIRELESS COMMUNICATION BASED ON A NETWORK CODING (NC) SCHEME

(71) Applicants: Javier Perez-Ramirez, North Plains, OR (US); Dave Cavalcanti, Portland, OR (US); Minyoung Park, San Ramon, CA (US); Wei Mao, San Jose, CA (US); Hosein Nikopour, San Jose, CA (US)

(72) Inventors: Javier Perez-Ramirez, North Plains, OR (US); Dave Cavalcanti, Portland, OR (US); Minyoung Park, San Ramon, CA (US); Wei Mao, San Jose, CA (US); Hosein Nikopour, San Jose, CA (US)

(21) Appl. No.: 17/957,001

(22) Filed: Sep. 30, 2022

(51) Int. Cl. H04W 74/08; H04L 1/00

(52) U.S. Cl. CPC H04W 74/0816; H04L 1/0009; H04L 1/0014

(57) ABSTRACT

In one example, a transmitter wireless communication device may be configured to encode k data packets into n encoded packets according to a Network Coding (NC) scheme, wherein k is equal to or greater than two, and wherein n is greater than k. For example, the transmitter wireless communication device may be configured to transmit k encoded packets of the n encoded packets during a plurality of transmission slots within a Synchronized Transmit Opportunity (S-TxOP), e.g., by transmitting one or more encoded packets of the k encoded packets during a transmission slot of the plurality of transmission slots. For example, the transmitter wireless communication device may be configured to transmit m other encoded packets of the n encoded packets during one or more subsequent transmission slots within the S-TxOP, for example, based on a determination that m packets of the k encoded packets have not been successfully received.

### TECHNICAL FIELD

Aspects described herein generally relate to wireless communication based on a Network Coding (NC) scheme.

### BACKGROUND

Some wireless communication networks may provide high-throughput data for users of wireless communication devices.

There is a need for technical solutions to provide increased and/or efficient access to the wireless communication medium.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic illustration of an Extremely High Throughput (EHT) Physical layer (PHY) Protocol Data Unit (PPDU) format, which may be implemented in accordance with some demonstrative aspects.

FIG. 3 is a schematic illustration of a Network Coding (NC) scheme, in accordance with some demonstrative aspects.

FIG. 4 is a schematic illustration of a wireless communication during a Synchronized Transmit Opportunity (S-TxOP), which may be implemented in accordance with some demonstrative aspects.

FIG. 5 is a schematic illustration of a Single User (SU) wireless communication according to an NC scheme during an S-TXOP, in accordance with some demonstrative aspects.

FIG. 6 is a schematic illustration of a Multi User (MU) wireless communication according to an NC scheme during an S-TXOP, in accordance with some demonstrative aspects.

FIG. 7 is a schematic flow-chart illustration of a method of wireless communication based on an NC scheme, in accordance with some demonstrative aspects.

FIG. 8 is a schematic flow-chart illustration of a method of wireless communication based on an NC scheme, in accordance with some demonstrative aspects.

FIG. 9 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some aspects may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, a wearable device, a sensor device, an Internet of Things (IoT) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may be used in conjunction with devices and/or networks operating in accordance with existing IEEE 802.11 standards (including IEEE 802.11-2020 (IEEE 802.11-2020, IEEE Standard for Information Technology—Telecommunications and Information Exchange between Systems Local and Metropolitan Area Networks—Specific Requirements; Part 11: Wireless LAN Medium Access Control (MAC) and Physical Layer (PHY) Specifications, December, 2020); and/or IEEE 802.11be (IEEE P802.11be/D2.0 Draft Standard for Information technology— Telecommunications and information exchange between systems Local and metropolitan area networks—Specific requirements; Part 11: Wireless LAN Medium Access Control (MAC) and Physical Layer (PHY) Specifications; Amendment 8: Enhancements for extremely high throughput (EHT), May 2022)) and/or future versions and/or derivatives thereof, devices and/or networks operating in accordance with existing cellular specifications and/or protocols, and/or future versions and/or derivatives thereof, units and/or devices which are part of the above networks, and the like.

Some aspects may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), 4G, Fifth Generation (5G), or Sixth Generation (6G) mobile networks, 3GPP, Long Term Evolution (LTE), LTE advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that may be integrated with a computer, or a peripheral that may be attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device. The communication signal may be transmitted and/or received, for example, in the form of Radio Frequency (RF) communication signals, and/or any other type of signal.

As used herein, the term “circuitry” may refer to, be part of, or include, an Application Specific Integrated Circuit (ASIC), an integrated circuit, an electronic circuit, a processor (shared, dedicated or group), and/or memory (shared. Dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

Some demonstrative aspects may be used in conjunction with a WLAN, e.g., a WiFi network. Other aspects may be used in conjunction with any other suitable wireless communication network, for example, a wireless area network, a “piconet”, a WPAN, a WVAN and the like.

Some demonstrative aspects may be used in conjunction with a wireless communication network communicating over a sub-10 Gigahertz (GHz) frequency band, for example, a 2.4 GHz frequency band, a 5 GHz frequency band, a 6 GHz frequency band, and/or any other frequency band below 10 GHz.

Some demonstrative aspects may be used in conjunction with a wireless communication network communicating over an Extremely High Frequency (EHF) band (also referred to as the “millimeter wave (mmWave)” frequency band), for example, a frequency band within the frequency band of between 20 Ghz and 300 GHz, for example, a frequency band above 45 GHz, e.g., a 60 GHz frequency band, and/or any other mmWave frequency band.

Some demonstrative aspects may be used in conjunction with a wireless communication network communicating over the sub-10 GHz frequency band and/or the mmWave frequency band, e.g., as described below. However, other aspects may be implemented utilizing any other suitable wireless communication frequency bands, for example, a 5G frequency band, a frequency band below 20 GHz, a Sub 1 GHz (S1G) band, a WLAN frequency band, a WPAN frequency band, and the like.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

Some demonstrative aspects may be implemented by an Extremely High Throughput (EHT) STA, which may include for example, a STA having a radio transmitter, which is capable of operating on a channel that is in frequency bands between 1 GHz and 7.250 Ghz. The EHT STA may perform other additional or alternative functionality. Other aspects may be implemented by any other apparatus, device and/or station.

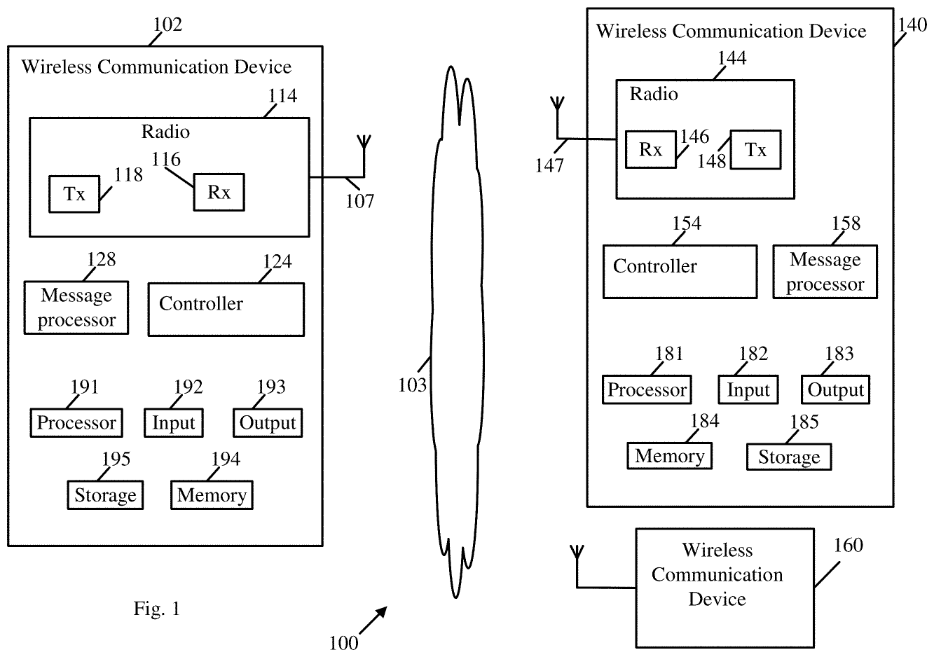

Reference is made to FIG. 1, which schematically illustrates a system 100, in accordance with some demonstrative aspects.

As shown in FIG. 1, in some demonstrative aspects, system 100 may include one or more wireless communication devices. For example, system 100 may include a wireless communication device 102, a wireless communication device 140, a wireless communication device 160, and/or one more other devices.

In some demonstrative aspects, devices 102, 140, and/or 160 may include a mobile device or a non-mobile, e.g., a static, device.

For example, devices 102, 140, and/or 160 may include, for example, a UE, an MD, a STA, an AP, a Smartphone, a PC, a desktop computer, a mobile computer, a laptop computer, an Ultrabook™ computer, a notebook computer, a tablet computer, a server computer, a handheld computer, an Internet of Things (IoT) device, a sensor device, a handheld device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a video source, an audio source, a video sink, an audio sink, a stereo tuner, a broadcast radio receiver, a digital audio player, a speaker, an audio receiver, an audio amplifier, a gaming device, a data source, a data sink, a media player, a television, a music player, a smart device such as, for example, lamps, climate control, car components, household components, appliances, and the like.

In some demonstrative aspects, device 102 may include, for example, one or more of a processor 191, an input unit 192, an output unit 193, a memory unit 194, and/or a storage unit 195; and/or device 140 may include, for example, one or more of a processor 181, an input unit 182, an output unit 183, a memory unit 184, and/or a storage unit 185. Devices 102 and/or 140 may optionally include other suitable hardware components and/or software components. In some demonstrative aspects, some or all of the components of one or more of devices 102 and/or 140 may be enclosed in a common housing or packaging, and may be interconnected or operably associated using one or more wired or wireless links. In other aspects, components of one or more of devices 102 and/or 140 may be distributed among multiple or separate devices.

In some demonstrative aspects, processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 may execute instructions, for example, of an Operating System (OS) of device 102 and/or of one or more suitable applications. Processor 181 may execute instructions, for example, of an OS of device 140 and/or of one or more suitable applications.

In some demonstrative aspects, input unit 192 and/or input unit 182 may include, for example, a keyboard, a keypad, a mouse, a touch-screen, a touch-pad, a track-ball, a stylus, a microphone, or other suitable pointing device or input device. Output unit 193 and/or output unit 183 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative aspects, memory unit 194 and/or memory unit 184 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 may include, for example, a hard disk drive, a disk drive, a solid-state drive (SSD), and/or other suitable removable or non-removable storage units. Memory unit 194 and/or storage unit 195, for example, may store data processed by device 102. Memory unit 184 and/or storage unit 185, for example, may store data processed by device 140.

In some demonstrative aspects, wireless communication devices 102, 140, and/or 160 may be capable of communicating content, data, information and/or signals via a wireless medium (WM) 103. In some demonstrative aspects, wireless medium 103 may include, for example, a radio channel, a cellular channel, an RF channel, a Wi-Fi channel, a 5G channel, an IR channel, a Bluetooth (BT) channel, a Global Navigation Satellite System (GNSS) Channel, and the like.

In some demonstrative aspects, WM 103 may include one or more wireless communication frequency bands and/or channels. For example, WM 103 may include one or more channels in a sub-10 Ghz wireless communication frequency band, for example, one or more channels in a 2.4 GHz wireless communication frequency band, one or more channels in a 5 GHz wireless communication frequency band, and/or one or more channels in a 6 GHz wireless communication frequency band. For example, WM 103 may additionally or alternatively include one or more channels in a mmWave wireless communication frequency band. In other aspects, WM 103 may include any other type of channel over any other frequency band.

In some demonstrative aspects, device 102, device 140, and/or device 160 may include one or more radios including circuitry and/or logic to perform wireless communication between devices 102, 140, 160, and/or one or more other wireless communication devices. For example, device 102 may include at least one radio 114, and/or device 140 may include at least one radio 144.

In some demonstrative aspects, radio 114 and/or radio 144 may include one or more wireless receivers (Rx) including circuitry and/or logic to receive wireless communication signals, RF signals, frames, blocks, transmission streams, packets, messages, data items, and/or data. For example, radio 114 may include at least one receiver 116, and/or radio 144 may include at least one receiver 146.

In some demonstrative aspects, radio 114 and/or radio 144 may include one or more wireless transmitters (Tx) including circuitry and/or logic to transmit wireless communication signals, RF signals, frames, blocks, transmission streams, packets, messages, data items, and/or data. For example, radio 114 may include at least one transmitter 118, and/or radio 144 may include at least one transmitter 148.

In some demonstrative aspects, radio 114 and/or radio 144, transmitters 118 and/or 148, and/or receivers 116 and/or 146 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like. For example, radio 114 and/or radio 144 may include or may be implemented as part of a wireless Network Interface Card (NIC), and the like.

In some demonstrative aspects, radios 114 and/or 144 may be configured to communicate over a 2.4 GHz band, a 5 GHz band, a 6 GHz band, a mmWave band, and/or any other band, for example, a 5G band, an S1G band, and/or any other band.

In some demonstrative aspects, radios 114 and/or 144 may include, or may be associated with one or more, e.g., a plurality of, antennas.

In some demonstrative aspects, device 102 may include one or more, e.g., a single antenna or a plurality of, antennas 107, and/or device 140 may include on or more, e.g., a plurality of, antennas 147.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. Antennas 107 and/or 147 may include, for example, antennas suitable for directional communication, e.g., using beamforming techniques. For example, antennas 107 and/or 147 may include a single antenna, a plurality of antennas, a phased array antenna, a multiple element antenna, a set of switched beam antennas, and/or the like. In some aspects, antennas 107 and/or 147 may implement transmit and receive functionalities using separate transmit and receive antenna elements. In some aspects, antennas 107 and/or 147 may implement transmit and receive functionalities using common and/or integrated transmit/receive elements.

In some demonstrative aspects, antennas 107 and/or antennas 147 may be connected to, and/or associated with, one or more Radio Frequency (RF) chains.

In some demonstrative aspects, device 102 may include a controller 124, and/or device 140 may include a controller 154. Controller 124 may be configured to perform and/or to trigger, cause, instruct and/or control device 102 to perform, one or more communications, to generate and/or communicate one or more messages and/or transmissions, and/or to perform one or more functionalities, operations and/or procedures between devices 102, 140, 160 and/or one or more other devices; and/or controller 154 may be configured to perform, and/or to trigger, cause, instruct and/or control device 140 to perform, one or more communications, to generate and/or communicate one or more messages and/or transmissions, and/or to perform one or more functionalities, operations and/or procedures between devices 102, 140, 160 and/or one or more other devices, e.g., as described below.

In some demonstrative aspects, controllers 124 and/or 154 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controllers 124 and/or 154, respectively. Additionally or alternatively, one or more functionalities of controllers 124 and/or 154 may be implemented by logic, which may be executed by a machine and/or one or more processors, e.g., as described below.

In one example, controller 124 may include circuitry and/or logic, for example, one or more processors including circuitry and/or logic, to cause, trigger and/or control a wireless device, e.g., device 102, and/or a wireless station, e.g., a wireless STA implemented by device 102, to perform one or more operations, communications and/or functionalities, e.g., as described herein. In one example, controller 124 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In one example, controller 154 may include circuitry and/or logic, for example, one or more processors including circuitry and/or logic, to cause, trigger and/or control a wireless device, e.g., device 140, and/or a wireless station, e.g., a wireless STA implemented by device 140, to perform one or more operations, communications and/or functionalities, e.g., as described herein. In one example, controller 154 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, at least part of the functionality of controller 124 may be implemented as part of one or more elements of radio 114, and/or at least part of the functionality of controller 154 may be implemented as part of one or more elements of radio 144.

In other aspects, the functionality of controller 124 may be implemented as part of any other element of device 102, and/or the functionality of controller 154 may be implemented as part of any other element of device 140.

In some demonstrative aspects, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below.

In one example, message processor 128 may include at least one first component configured to generate a message, for example, in the form of a frame, field, information element and/or protocol data unit, for example, a MAC Protocol Data Unit (MPDU); at least one second component configured to convert the message into a PHY Protocol Data Unit (PPDU), for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 128 may be configured to perform any other additional or alternative functionality and/or may include any other additional or alternative components to generate and/or process a message to be transmitted.

In some demonstrative aspects, device 140 may include a message processor 158 configured to generate, process and/or access one or messages communicated by device 140.

In one example, message processor 158 may be configured to generate one or more messages to be transmitted by device 140, and/or message processor 158 may be configured to access and/or to process one or more messages received by device 140, e.g., as described below.

In one example, message processor 158 may include at least one first component configured to generate a message, for example, in the form of a frame, field, information element and/or protocol data unit, for example, an MPDU; at least one second component configured to convert the message into a PPDU, for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 158 may be configured to perform any other additional or alternative functionality and/or may include any other additional or alternative components to generate and/or process a message to be transmitted.

In some demonstrative aspects, message processors 128 and/or 158 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, BB circuitry and/or logic, a BB processor, a BB memory, AP circuitry and/or logic, an AP processor, an AP memory, and/or any other circuitry and/or logic, configured to perform the functionality of message processors 128 and/or 158, respectively. Additionally or alternatively, one or more functionalities of message processors 128 and/or 158 may be implemented by logic, which may be executed by a machine and/or one or more processors, e.g., as described below.

In some demonstrative aspects, at least part of the functionality of message processor 128 may be implemented as part of radio 114, and/or at least part of the functionality of message processor 158 may be implemented as part of radio 144.

In some demonstrative aspects, at least part of the functionality of message processor 128 may be implemented as part of controller 124, and/or at least part of the functionality of message processor 158 may be implemented as part of controller 154.

In other aspects, the functionality of message processor 128 may be implemented as part of any other element of device 102, and/or the functionality of message processor 158 may be implemented as part of any other element of device 140.

In some demonstrative aspects, at least part of the functionality of controller 124 and/or message processor 128 may be implemented by an integrated circuit, for example, a chip, e.g., a System on Chip (SoC). In one example, the chip or SoC may be configured to perform one or more functionalities of radio 114. For example, the chip or SoC may include one or more elements of controller 124, one or more elements of message processor 128, and/or one or more elements of radio 114. In one example, controller 124, message processor 128, and radio 114 may be implemented as part of the chip or SoC.

In other aspects, controller 124, message processor 128 and/or radio 114 may be implemented by one or more additional or alternative elements of device 102.

In some demonstrative aspects, at least part of the functionality of controller 154 and/or message processor 158 may be implemented by an integrated circuit, for example, a chip, e.g., a System on Chip (SoC). In one example, the chip or SoC may be configured to perform one or more functionalities of radio 144. For example, the chip or SoC may include one or more elements of controller 154, one or more elements of message processor 158, and/or one or more elements of radio 144. In one example, controller 154, message processor 158, and radio 144 may be implemented as part of the chip or SoC.

In other aspects, controller 154, message processor 158 and/or radio 144 may be implemented by one or more additional or alternative elements of device 140.

In some demonstrative aspects, device 102, device 140, and/or device 160 may include, operate as, perform the role of, and/or perform one or more functionalities of, one or more STAs. For example, device 102 may include at least one STA, device 140 may include at least one STA, and/or device 160 may include at least one STA.

In some demonstrative aspects, device 102, device 140, and/or device 160 may include, operate as, perform the role of, and/or perform one or more functionalities of, one or more EHT STAs. For example, device 102 may include, operate as, perform the role of, and/or perform one or more functionalities of, at least one EHT STA; device 140 may include, operate as, perform the role of, and/or perform one or more functionalities of, at least one EHT STA; and/or device 160 may include, operate as, perform the role of, and/or perform one or more functionalities of, at least one EHT STA.

In other aspects, devices 102, 140 and/or 160 may include, operate as, perform the role of, and/or perform one or more functionalities of, any other wireless device and/or station, e.g., a WLAN STA, a Wi-Fi STA, and the like.

In some demonstrative aspects, device 102, device 140, and/or device 160 may be configured operate as, perform the role of, and/or perform one or more functionalities of, an access point (AP), e.g., an EHT AP, or any other AP.

In some demonstrative aspects, device 102, device 140, and/or device 160 may be configured to operate as, perform the role of, and/or perform one or more functionalities of, a non-AP STA, e.g., an EHT non-AP STA, pr any other non-AP STA.

In other aspects, device 102, device 140, and/or device 160 may operate as, perform the role of, and/or perform one or more functionalities of, any other additional or alternative device and/or station.

In one example, a station (STA) may include a logical entity that is a singly addressable instance of a medium access control (MAC) and physical layer (PHY) interface to the wireless medium (WM). The STA may perform any other additional or alternative functionality.

In one example, an AP may include an entity that contains a station (STA), e.g., one STA, and provides access to distribution services, via the wireless medium (WM) for associated STAs. The AP may perform any other additional or alternative functionality.

In one example, a non-AP STA may include a STA that is not contained within an AP. The non-AP STA may perform any other additional or alternative functionality.

In some demonstrative aspects devices 102, 140 and/or 160 may be configured to communicate over an EHT network, and/or any other network. For example, devices 102, 140 and/or 160 may perform Multiple-Input-Multiple-Output (MIMO) communication, for example, for communicating over the EHT networks, e.g., over an EHT frequency band, e.g., in frequency bands between 1 GHz and 7.250 GHz.

In some demonstrative aspects, devices 102, 140 and/or 160 may be configured to operate in accordance with one or more Specifications, for example, including one or more IEEE 802.11 Specifications, e.g., an IEEE 802.11-2020 Specification, an IEEE 802.11be Specification, and/or any other specification and/or protocol.

In some demonstrative aspects, devices 102, 140 and/or 160 may be configured according to one or more standards, for example, in accordance with an IEEE 802.11be Standard, which may be configured, for example, to enhance the efficiency and/or performance of an IEEE 802.11 Specification, which may be configured to provide Wi-Fi connectivity.

Some demonstrative aspects may enable, for example, to significantly increase the data throughput defined in the IEEE 802.11-2020 Specification, for example, up to a throughput of 30 Giga bits per second (Gbps), or to any other throughput, which may, for example, satisfy growing demand in network capacity for new coming applications.

Some demonstrative aspects may be implemented, for example, to support increasing a transmission data rate, for example, by applying MIMO and/or Orthogonal Frequency Division Multiple Access (OFDMA) techniques.

In some demonstrative aspects, devices 102, 140 and/or 160 may be configured to communicate MIMO communications and/or OFDMA communication in frequency bands between 1 GHz and 7.250 GHz.

In some demonstrative aspects, device 102, device 140 and/or device 160 may be configured to support one or more mechanisms and/or features, for example, OFDMA, Single User (SU) MIMO, and/or Multi-User (MU) MIMO, for example, in accordance with an IEEE 802.11be Standard and/or any other standard and/or protocol.

In some demonstrative aspects, device 102, device 140 and/or device 160 may include, operate as, perform a role of, and/or perform the functionality of, one or more EHT STAs. For example, device 102 may include, operate as, perform a role of, and/or perform the functionality of, at least one EHT STA, device 140 may include, operate as, perform a role of, and/or perform the functionality of, at least one EHT STA, and/or device 160 may include, operate as, perform a role of, and/or perform the functionality of, at least one EHT STA.

In some demonstrative aspects, devices 102, 140 and/or 160 may implement a communication scheme, which may include Physical layer (PHY) and/or Media Access Control (MAC) layer schemes, for example, to support one or more applications, and/or increased throughput, e.g., throughputs up to 30 Gbps, or any other throughput.

In some demonstrative aspects, the PHY and/or MAC layer schemes may be configured to support OFDMA techniques, SU MIMO techniques, and/or MU MIMO techniques.

In some demonstrative aspects, devices 102, 140 and/or 160 may be configured to implement one or more mechanisms, which may be configured to enable SU and/or MU communication of Downlink (DL) and/or Uplink frames (UL) using a MIMO scheme.

In some demonstrative aspects, device 102, device 140 and/or device 160 may be configured to implement one or more MU communication mechanisms. For example, devices 102, 140 and/or 160 may be configured to implement one or more MU mechanisms, which may be configured to enable MU communication of DL frames using a MIMO scheme, for example, between a device, e.g., device 102, and a plurality of devices, e.g., including device 140, device 160, and/or one or more other devices.

In some demonstrative aspects, devices 102, 140, and/or 160 may be configured to communicate over an EHT network, and/or any other network and/or any other frequency band. For example, devices 102, 140, and/or 160 may be configured to communicate DL transmissions and/or UL transmissions, for example, for communicating over the EHT networks.

In some demonstrative aspects, devices 102, 140 and/or 160 may be configured to communicate over a channel bandwidth, e.g., of at least 20 Megahertz (MHz), in frequency bands between 1 GHz and 7.250 GHz.

In some demonstrative aspects, devices 102, 140 and/or 160 may be configured to implement one or more mechanisms, which may, for example, support communication over a wide channel bandwidth (BW) (“channel width”) (also referred to as a “wide channel” or “wide BW”) covering two or more channels, e.g., two or more 20 MHz channels, e.g., as described below.

In some demonstrative aspects, wide channel mechanisms may include, for example, a mechanism and/or an operation whereby two or more channels, e.g., 20 MHz channels, can be combined, aggregated or bonded, e.g., for a higher bandwidth of packet transmission, for example, to enable achieving higher throughputs, e.g., when compared to transmissions over a single channel. Some demonstrative aspects are described herein with respect to communication over a channel BW including two or more 20 MHz channels, however other aspects may be implemented with respect to communications over a channel bandwidth, e.g., a “wide” channel, including or formed by any other number of two or more channels, for example, a bonded or aggregated channel including a bonding or an aggregation of two or more channels.

In some demonstrative aspects, device 102, device 140 and/or device 160 may be configured to communicate one or more transmissions over one or more channel BWs, for example, including a channel BW of 20 MHz, a channel BW of 40 MHz, a channel BW of 80 MHz, a channel BW of 160 MHz, a channel BW of 320 MHz, and/or any other additional or alternative channel BW, e.g., as described below.

In some demonstrative aspects, devices 102, 140 and/or 160 may be configured to generate, process, transmit and/or receive a Physical Layer (PHY) Protocol Data Unit (PPDU) having a PPDU format (also referred to as “EHT PPDU format”), which may be configured, for example, for communication between EHT stations, e.g., as described below.

In some demonstrative aspects, a PPDU, e.g., an EHT PPDU, may include at least one non-EHT field, e.g., a legacy field, which may be identified, decodable, and/or processed by one or more devices (“non-EHT devices”, or “legacy devices”), which may not support one or more features and/or mechanisms (“non-legacy” mechanisms or “non-EHT mechanisms”). For example, the legacy devices may include non-EHT stations and/or non-High Throughput (HT) stations, which may be, for example, configured according to an IEEE 802.11-2020 Standard, and the like.

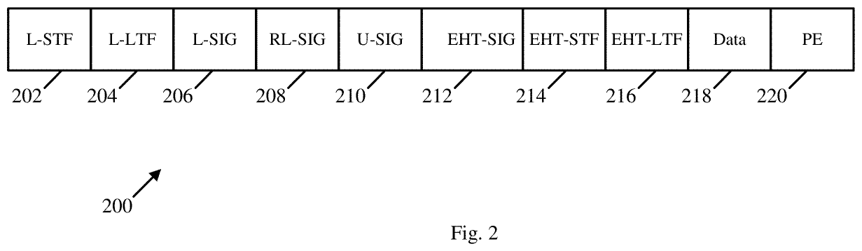

Reference is made to FIG. 2, which schematically illustrates an EHT PPDU format 200, which may be implemented in accordance with some demonstrative aspects. In one example, devices 102 (FIG. 1), 140 (FIG. 1), and/or 160 (FIG. 1) may be configured to generate, transmit, receive and/or process one or more EHT PPDUs having the structure and/or format of EHT PPDU 200.

In one example, devices 102 (FIG. 1), 140 (FIG. 1), and/or 160 (FIG. 1) may communicate EHT PPDU 200, for example, as part of a transmission over a channel, e.g., an EHT channel, having a channel bandwidth including one or more 20 MHz channels, for example, a channel BW of 20 MHz, a channel BW of 40 MHz, a channel BW of 80 MHz, a channel BW of 160 MHz, a channel BW of 320 MHz, and/or any other additional or alternative channel BW, e.g., as described below.

In some demonstrative aspects, EHT PPDU 200 may include an EHT SU PPDU, which may be utilized for transmission from an EHT STA, e.g., an EHT STA implemented by device 102 (FIG. 1), to one another STA, e.g., an EHT STA implemented by device 140 (FIG. 1).

In some demonstrative aspects, EHT PPDU 200 may include an EHT MU PPDU, which may be utilized for transmission from an EHT STA, e.g., an EHT STA implemented by device 102 (FIG. 1), to one or more users, for example, one or more EHT STAs, including an EHT STA implemented by device 140 (FIG. 1) and/or an EHT STA implemented by device 140 (FIG. 1).

In some demonstrative aspects, as shown in FIG. 2, EHT PPDU 200 may include a non-High Throughput (non-HT) (legacy) Short Training Field (STF) (L-STF) 202, followed by a non-HT (Legacy) Long Training Field (LTF) (L-LTF) 204, which may be followed by a non-HT Signal (SIG) (L-SIG) field 206.

In some demonstrative aspects, as shown in FIG. 2, EHT PPDU 200 may include a repeated non-HT SIG (RL-SIG) field 208, which may follow the L-SIG field 206. The RL-SIG field 208 may be followed by a Universal SIG (U-SIG) field 210.

In some demonstrative aspects, as shown in FIG. 2, EHT PPDU 200 may include a plurality of EHT-modulated fields, e.g., following the U-SIG field 210.

In some demonstrative aspects, as shown in FIG. 2, the EHT modulated fields may include, for example, an EHT Signal (EHT-SIG) field 212.

In some demonstrative aspects, as shown in FIG. 2, the EHT modulated fields may include, for example, an EHT STF (EHT-STF) field 214, e.g., following the EHT-SIG field 212.

In some demonstrative aspects, as shown in FIG. 2, the EHT modulated fields may include, for example, an EHT LTF (EHT-LTF) field 216, e.g., following the EHT-STF field 214.

In some demonstrative aspects, as shown in FIG. 2, the EHT modulated fields may include, for example, a data field 218, e.g., following the EHT-LTF field 216, and/or a Packet Extension (PE) field 220, e.g., following the data field 218.

In some demonstrative aspects, EHT PPDU 200 may include some or all of the fields shown in FIG. 2 and/or one or more other additional or alternative fields.

Referring back to FIG. 1, in some demonstrative aspects, devices 102, 140, and/or 160 may be configured to generate, transmit, receive and/or process one or more transmissions, e.g., including one or more EHT PPDUs, e.g., as described below.

In some demonstrative aspects, for example, devices 102, 140, and/or 160 may be configured to perform one or more operations, and/or functionalities of an EHT STA, which may be configured, for example, to generate, transmit, receive and/or process one or more transmissions, e.g., including one or more EHT PPDUs, e.g., including one or more fields according to the EHT PPDU format of FIG. 2.

In some demonstrative aspects, devices 102, 140, and/or 160 may be configured to generate, transmit, receive and/or process an EHT PPDU, e.g., in accordance with an IEEE 802.11be Specification and/or any other specification, e.g., as described below.

In some demonstrative aspects, for example, devices 102, 140, and/or 160 may be configured to perform one or more operations, and/or functionalities of an EHT STA, which may be configured, for example, to generate, transmit, receive and/or process the EHT PPDU as an EHT MU PPDU, for example, in accordance with the EHT PPDU formal 200 (FIG. 2).

In some demonstrative aspects, the EHT MU PPDU may include a PPDU that carries one or more PHY service data units (PSDUs) for one or more STAs using a downlink multi-user multiple input, multiple output (DL-MU-MIMO) technique, an orthogonal frequency division multiple access (DL OFDMA) technique, or a combination of the two techniques.

In some demonstrative aspects, for example, devices 102, 140 and/or 160 may be configured to perform one or more operations, and/or functionalities of an EHT STA, which may be configured, for example, to generate, transmit, receive and/or process the EHT MU PPDU, for example, over a 20 MHz channel width, a 40 MHz channel width, a 80 MHz channel width, a 160 MHz channel width, and/or a 320 Mhz channel width.

In other aspects, any other additional or alternative channel width may be utilized.

In other aspects, for example, devices 102, 140 and/or 160 may be configured to perform one or more operations, and/or functionalities of a WiFi 8 STA.

In other aspects, for example, devices 102, 140 and/or 160 may be configured to perform one or more operations, and/or functionalities of any other additional or alternative type of STA.

In some demonstrative aspects, devices 102, 140 and/or 160 may be configured to implement a low-latency wireless communication mechanism, which may be configured to provide a technical solution to support low-latency transmissions, e.g., very-low latency or ultra-low latency transmissions, in a wireless communication network, for example, a Wi-Fi network, e.g., as described below.

In some demonstrative aspects, devices 102, 140 and/or 160 may be configured to implement a low-latency wireless communication mechanism, which may be configured to provide a technical solution to support high throughput, low-latency, high determinism, and/or high reliability, e.g., as described below.

In some demonstrative aspects, the low-latency wireless communication mechanism may be configured to provide a technical solution to support emerging time-sensitive wireless communications, e.g., as described below.

In some demonstrative aspects, devices 102, 140 and/or 160 may be configured to implement a low-latency wireless communication mechanism, which may be configured to provide a technical solution to support an efficient way to deliver a packet with high throughput, high reliability, low latency, and/or high determinism, e.g., as described below.

In some demonstrative aspects, devices 102, 140 and/or 160 may include an Ultra-Low-Latency (ULL) STA, which may be configured to communicate low-latency transmissions, e.g., as described below.

In one example, the ULL STA may be configured to support enhanced reliability and/or reduced latency, for example, to support wireless-based applications, such as Fourth Industrial Revolution (4IR) (also referred to as Industry 4.0) applications, Extended Reality (XR) applications, e.g., Augmented Reality (AR) applications, and/or Virtual Reality (VR) applications, and/or any other applications, which may require ultra-low latency and/or very high reliability.

In some demonstrative aspects, there may be a need to provide a technical solution to support wireless communication of packets with a high level of reliability and/or a low latency.

For example, an increasing number of more wireless-based applications may require high reliability and/or low latency. For example, some wireless communication technologies, e.g., Wi-Fi technologies, may utilize an Automatic repeat request (ARQ) mechanism to support high reliability. However the ARQ mechanism may be spectrally inefficient. For example, the ARQ mechanism may be highly inefficient in some cases. In one example, the ARQ mechanism may introduce high overhead for small data packets.

In some demonstrative aspects, vices 102, 140 and/or 160 may be configured to communicate wireless transmissions according to a wireless communication technique, which may be configured to provide a technical solution to successfully deliver k packets, e.g., equal-sized data packets, to a receiver over a Wi-Fi link, e.g., while using a reduced amount, e.g., a minimal amount, of radio resources, e.g., as described below.

In some demonstrative aspects, devices 102, 140 and/or 160 may be configured to communicate wireless transmissions based on a Network Coding (NC) scheme, e.g., as described below.

In some demonstrative aspects, the NC scheme may include a linear packet-level coding scheme, e.g., as described below. In other aspects, any other NC scheme may be implemented.

In some demonstrative aspects, the NC scheme may be based on linear packet erasure codes.

In some demonstrative aspects, the NC scheme may be based on forward error correction codes.

In other aspects, the NC scheme may be based on any other type of codes, which may be configured for network coding.

In some demonstrative aspects, devices 102, 140 and/or 160 may be configured to communicate wireless transmissions based on the NC scheme, for example, to provide a technical solution to support low-latency and/or high-reliability data traffic, e.g., as described below.

In some demonstrative aspects, the NC scheme may be configured to combine, e.g., to linearly combine, data packets, for example, to form new encoded packets having dependence among them, e.g., as described below.

In some demonstrative aspects, wireless transmissions according to the NC scheme may be implemented provide a technical solution to support recovery of the original data packets, for example, even in case only some of the encoded packets are successfully received. For example, as long as a sufficient number of encoded packets, e.g., regardless of which ones, are correctly received at the receiver, the original data packets may be recovered, for example, despite possible losses of all other encoded packets.

In some demonstrative aspects, wireless transmissions according to the NC scheme may be implemented to provide a technical solution to proactively add redundancy to the traffic and/or to significantly reduce latency, e.g., compared to repetition schemes.

In some demonstrative aspects, wireless transmissions according to the NC scheme may be implemented to provide a technical solution, which is much more spectrally efficient, e.g., compared to packet repetition techniques, for example, while not requiring too much additional computational complexity for encoding and decoding.

In some demonstrative aspects, devices 102, 140 and/or 160 may be configured to communicate wireless transmissions based on the NC scheme, which may be configured to encode a plurality of data packets, e.g., including k data packets, into a plurality of encoded packets, e.g., including n>k encoded packets, e.g., as described below.

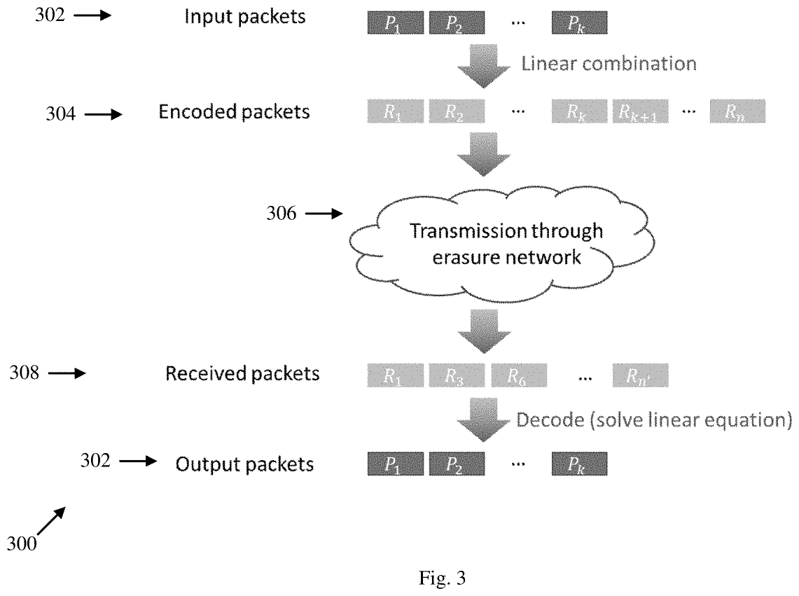

Reference is made to FIG. 3, which schematically illustrates an NC scheme 300, in accordance with some demonstrative aspects. For example, devices 102, 140 and/or 160 may be configured to communicate wireless transmissions based on the NC scheme 300.

For example, the NC scheme 300 may be based on a linear packet-level coding, e.g., as described below.

For example, as shown in FIG. 3, a set of n coded packets 304, denoted [R₁, R₂, . . . , Rₙ], may be determined by encoding a set of k packets 302, e.g., k same-sized packets, denoted [P₁, P₂, . . . , Pₖ], which may be viewed as column vectors over a finite field, e.g., a Galois Field IF.

For example, a linearly coded packet may be constructed as R=Σᵢ₌₁^{k}cᵢ·Pᵢ, for example, based on an encoding vector [c₁, c₂ . . . , cₖ]^{T}, which may include coefficients chosen from the Field [symbol] .

For example, the set of n coded packets 304 may be determined, e.g., as follows:

Rⱼ=Σᵢ₌₁^{k}cᵢⱼPᵢ,cᵢⱼ∈

[symbol]

[R₁,R₂, . . . ,Rₙ]=[P₁,P₂ . . . Pₖ][cᵢⱼ]_{k×n},

For example, as shown in FIG. 3, the set of n coded packets 304 may be transmitted through a lossy channel/network 306, where packets may be dropped (erasure). For example, packet lose may correspond to deletion of columns of [cᵢⱼ].

For example, as shown in FIG. 3, the NC scheme 300 may be configured to generate the set of n coded packets 304, for example, such that a receiver may still be able to recover the original packets [P₁, P₂, . . . , Pₖ], for example, even if the receiver receives only k received encoded packets 308, denoted [R₁, R₂, . . . , Rₖ], of the n network coded packets that are linearly independent. For example, the receiver may recover the original packets [P₁, P₂, . . . , Pₖ] by determining [R₁ R₂ . . . Rₖ]M⁻¹, wherein:

$$M = [ \begin{matrix}{c}_{1}^{1} & {c}_{1}^{2} & … & {c}_{1}^{k} \\ {c}_{2}^{1} & {c}_{2}^{2} & … & {c}_{2}^{k} \\ ⋮ & ⋮ & … & ⋮ \\ {c}_{k}^{1} & {c}_{k}^{2} & … & {c}_{k}^{k}\end{matrix} ]$$

wherein the i-th column of the matrix M may include the encoding vector for Rᵢ.

For example, the NC scheme 300 may be implemented to provide a technical solution to support an improved rate-reliability trade-off, e.g., compared to repetition techniques. For example, the improvement of the rate-reliability trade-off may increase with an increase in the coding group size (k).

For example, coding coefficients of the NC scheme 300, e.g., the coefficients cₖ may be chosen, for example, from codes with good performances, e.g., with a Maximum Distance Separable (MDS) property, for example, such that any choices of k encoding vectors may be linearly independent. In other aspects, any other coefficients may be implemented according to any other performance properties.

Referring back to FIG. 1, in some demonstrative aspects, devices 102, 140 and/or 160 may be configured to communicate wireless transmissions based on a NC scheme, e.g., the NC scheme of FIG. 3, combined with a TDMA scheduled MAC transmission mode, for example, to provide a technical solution to support highly efficient and reliable Wi-Fi communications, e.g., as escribed below.

In some demonstrative aspects, devices 102, 140 and/or 160 may be configured to support wireless communication according to a Synchronized Transmit Opportunity (S-TxOP) mechanism, e.g., as described below.

In some demonstrative aspects, the S-TxOP mechanism may be configured to provide a technical solution to support ultra-low latency communication within a TxOP obtained by an AP.

For example, an S-TxOP may be configured to provide a technical solution to support Downlink (DL) and/or Uplink (UL) data communication, for example, with a low control overhead.

For example, one or more communications during the S-TxOP may be configured to utilize a preamble format, which may be configured to support a technical solution for optimizing a preamble length, for example, to support low control overhead during the S-TxOP, e.g., as described below.

For example, one or more communications during the S-TxOP may be configured to utilize a resource allocation signaling mechanism, which may be configured to support a technical solution, for example, to support low control overhead during the S-TxOP, e.g., as described below.

For example, one or more communications during the S-TxOP may be configured to utilize an acknowledgement scheme, which may be configured to support a technical solution for supporting a lightweight acknowledgement, for example, to support low control overhead during the S-TxOP, e.g., as described below.

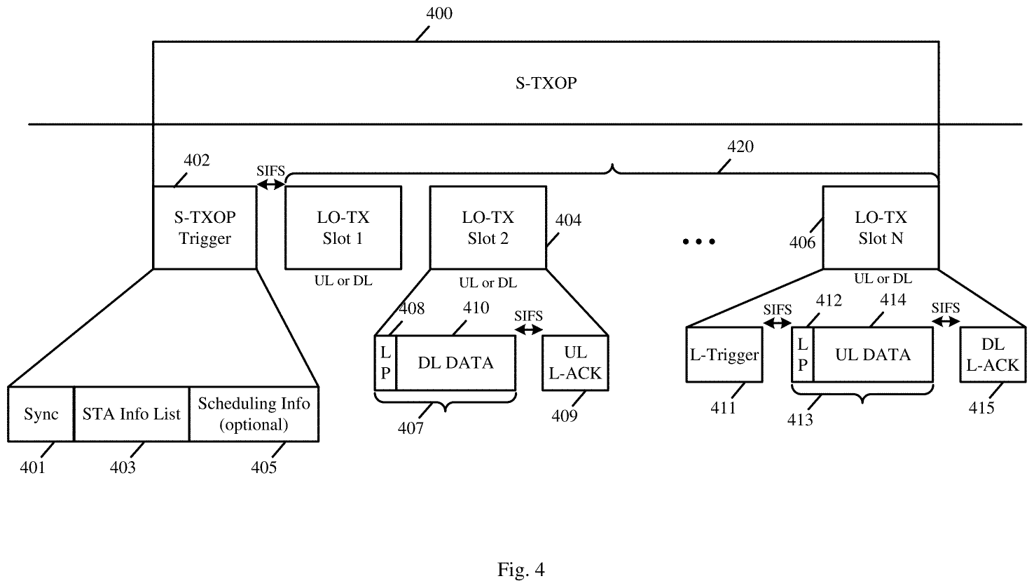

Reference is made to FIG. 4, which schematically illustrates communications during an S-TxOP 400, which may be implemented in accordance with some demonstrative aspects.

In some demonstrative aspects, an AP, e.g., an AP implemented by device 102 (FIG. 1), may be configured to communicate with one or more STAs, e.g., a STA implemented by device 140 (FIG. 1) and/or a STA implemented by device 160 (FIG. 1), over a wireless communication channel during the S-TxOP 400, e.g., as described below.

For example, as shown in FIG. 4, the S-TxOP 400 may be configured to include an S-TXOP trigger phase, during which one or more Physical layer Protocol Data Units (PPDUs) and/or frames may be communicated by the AP and the one or more STAs participating in the S-TxOP 400.

For example, the one or more PPDUs and/or frames communicated during the S-TXOP trigger phase may be configured to support synchronization between one or more STAs participating in the S-TXOP 400 to synchronize to the AP.

For example, the one or more PPDUs and/or frames communicated during the S-TXOP trigger phase may be configured to support the AP in signaling to the to one or more STAs participating in the S-TXOP 400 which slots are scheduled to which STAs for communication during the S-TXOP 400.

For example, the one or more PPDUs and/or frames communicated during the S-TXOP trigger phase may be configured to support the AP in signaling to the to one or more STAs participating in the S-TXOP 400 resource allocations corresponding to the slots scheduled for communication during the S-TXOP 400.

For example, as shown in FIG. 4, an AP, e.g., the AP implemented by device 102 (FIG. 1), may be configured to transmit an S-TxOP trigger frame 402, for example, during the S-TXOP Trigger phase, e.g., as described below.

For example, as shown in FIG. 4, the AP, e.g., the AP implemented by device 102 (FIG. 1), may be configured to communicate the S-TxOP trigger frame 402 with one or more STAs, e.g., including the STA implemented by device 140 (FIG. 1) and/or including the STA implemented by device 160 (FIG. 1), for example, to initiate the S-TxOP 400, e.g., as described below.

For example, a preamble, e.g., a modified legacy preamble, of the S-TxOP trigger frame 402 may be used to trigger multiple transmissions, e.g., UL and/or DL transmissions. One or more fields and/or portions in the S-TxOP trigger frame 402, e.g., the preamble and/or one or more other portions of the S-TXOP trigger frame 402, may be configured to include information to notify each of the stations involved in the transmission when they are expected to transmit and/or receive data during the S-TXOP 400.

In some demonstrative aspects, the S-TxOP 400 may be configured utilizing a preamble, e.g., a single modified legacy preamble, which may include resource allocation signaling, e.g., optimized resource allocation signaling, for example, to support semi-static scheduling.

For example, a single preamble may be utilized for resource allocation signaling for the whole duration of the S-TxOP 400, for example, to provide a technical solution to support a highly efficient and/or low latency transmission of data packets.

For example, the S-TxOP 400 may be utilized to provide a technical solution to support a highly efficient and/or low latency transmission of relatively small data packets, e.g., with a size of about 100 bytes and/or any other size, which may be, for example, transmitted periodically.

In some demonstrative aspects, the S-TxOP 400 may be configured to support a combination of UL and DL time slots in the S-TXOP duration, for example, to facilitates immediate acknowledgement of successful UL and/or DL transmissions, e.g., as described below.

For example, as shown in FIG. 4, the S-TxOP trigger frame 402 may include a sync field 401, for example, to synchronize one or more STAs to the AP. For example, the sync field 401 may include synchronization information to synchronize the STA implemented by device 140 (FIG. 1) and/or the STA implemented by device 160 (FIG. 1) to the AP implemented by device 102 (FIG. 1).

For example, as shown in FIG. 4, the S-TxOP trigger frame 402 may include a STA Info list field 403. For example, the STA Info list field 403 may include information regarding the one or more STAs to participate in the S-TxOP 400.

For example, as shown in FIG. 4, the S-TxOP trigger frame 402 may include a scheduling information field 405. For example, the scheduling information field 405 may include transmit configuration information regarding transmission slots to be scheduled during the S-TxOP 400.

For example, as shown in FIG. 4, the S-TxOP 400 may include a plurality of low-overhead (LO) transmission (Tx) (LO-Tx) slots 420, e.g., as described below. For example, the S-TxOP trigger frame 402 may be configured to schedule the LO-Tx slots 420.

For example, the plurality of LO transmission slots 420 may be synchronized, for example, based on the S-TxOP trigger frame 402.

For example, as shown in FIG. 4, two consecutive LO-Tx slots 420, e.g., each pair of consecutive LO-Tx slots 420, may be separated by a Short Interframe Space (SIFS) from one another.

For example, as shown in FIG. 4, the LO-Tx slots 420 may include one or more DL LO-Tx slots, which may be scheduled for DL transmissions, for example, from the AP to the one or more STAs.

For example, as shown in FIG. 4, the LO-Tx slots 420 may include one or more UL LO-Tx slots, which may be scheduled for UL transmissions, for example, the one or more STAs to the AP.

For example, as shown in FIG. 4, the AP, e.g., the AP implemented by device 102 (FIG. 1), may be configured to transmit at least one LO DL PPDU 407, for example, during a DL LO-Tx slot 404 of the plurality of LO-Tx slots 420.

For example, the AP, e.g., the AP implemented by device 102, (FIG. 1), may be configured to transmit the LO DL PPDU 407 to one or more STAs, e.g., including the STA implemented by device 140 (FIG. 1) and/or the STA implemented by device 160 (FIG. 1).

For example, as shown in FIG. 4, the LO DL PPDU 407 may include a low-overhead preamble (LP) (also referred to as “lite preamble”) 408, and a DL Data field 410.

For example, as shown in FIG. 4, a STA addressed by the LO DL PPDU 407, e.g., the STA implemented by device 140 (FIG. 1) and/or the STA implemented by device 160 (FIG. 1), may be configured to transmit to the AP an UL acknowledgement (ACK) frame 409, for example, during the LO-Tx slot 404, e.g., as described below.

For example, the UL ACK frame 409 may be configured to acknowledge receipt of the LO DL PPDU 407 by the STA.

For example, as shown in FIG. 4, the UL ACK frame 409 may be after the LO DL PPDU 407, for example, no more than a SIFS after the LO DL PPDU 407.

For example, as shown in FIG. 4, a STA participating in the S-TxOP 400, e.g., the STA implemented by device 140 (FIG. 1) and/or the STA implemented by device 160 (FIG. 1), may be configured to transmit a LO UL PPDU 413 to the AP, for example, during a LO-Tx slot 406 of the plurality of LO transmission slots 420.

For example, the AP implemented by device 102 (FIG. 1) may be configured to receive the LO UL PPDU 413 from the STA implemented by device 140 (FIG. 1) and/or the STA implemented by device 160 (FIG. 1).

For example, as shown in FIG. 4, the AP implemented by device 102 (FIG. 1) may be configured to transmit a low overhead trigger (also referred to as “lite trigger”) (L-Trigger) frame 411 during the LO transmission slot 406, for example, to trigger transmission of the LO UL PPDU 413.

For example, the AP implemented by device 102 (FIG. 1) may be configured to transmit L-Trigger frame 411 to trigger the transmission of the LO UL PPDU 413 from the STA implemented by device 140 (FIG. 1) and/or the STA implemented by device 160 (FIG. 1).

For example, as shown in FIG. 4, the LO UL PPDU 413 may include an LP 412, and an UL Data field 414.

For example, as shown in FIG. 4, the LO UL PPDU 413 may be after the L-Trigger frame 411, for example, no more than a SIFS after the L-Trigger frame 411.

For example, as shown in FIG. 4, the AP, e.g., the AP implemented by device 102 (FIG. 1), may be configured to transmit to the STA a DL ACK frame 415, for example, during the LO-Tx slot 406.

For example, the DL ACK frame 415 may be configured to acknowledge receipt of the LO UL PPDU 413 by the AP.

For example, as shown in FIG. 4, the DL ACK frame 415 may be after the LO UL PPDU 413, for example, no more than a SIFS after the LO UL PPDU 413.

Referring back to FIG. 1, in some demonstrative aspects, devices 102, 140 and/or 160 may be configured to perform one or more operations and/or communications according to an S-TxOP mechanism according to the configuration of S-TxOP 400 (FIG. 4). In other aspects, devices 102, 140 and/or 160 may be configured to perform any other additional and/or alternative operations and/or communications according to any other S-TxOP mechanism.

In some demonstrative aspects, devices 102, 140 and/or 160 may be configured to communicate wireless transmissions based on a combination of an NC scheme, e.g., the NC scheme of FIG. 3, combined with an S-TxOP scheme, e.g., the S-TxOP scheme of FIG. 4, for example, to provide a technical solution to support highly efficient and reliable communications, e.g., as escribed below.

In some demonstrative aspects, a wireless communication device, e.g., device 102, device 140 and/or device 160, may be configured to encode a plurality of data packets, for example, a stream of data packets, e.g., including k data packets, into a plurality of encoded packets, for example, a stream of encoded packets, e.g., including n encoded packets, according to an NC scheme, e.g., as described below.

In some demonstrative aspects, the wireless communication device, e.g., device 102, device 140 and/or device 160, may be configured to transmit k encoded packets of the n encoded packets during a plurality of transmission slots within an S-TxOP, e.g., as described below.

In some demonstrative aspects, the wireless communication device, e.g., device 102, device 140 and/or device 160, may be configured to transmit the k encoded packets by transmitting one or more encoded packets of the k encoded packets during a transmission slot of the plurality of transmission slots within the S-TxOP, e.g., as described below.

In some demonstrative aspects, the wireless communication device, e.g., device 102, device 140 and/or device 160, may be configured to transmit m other encoded packets of the n encoded packets during one or more subsequent transmission slots within the S-TxOP, for example, based on a determination that m packets of the k encoded packets have not been successfully received. For example, the value of m may be equal to or greater than 1, e.g., as described below.

In some demonstrative aspects, controller 124 may be configured to control, trigger, cause, and/or instruct device 102 to communicate the k data packets as part of a transmission, e.g., a downlink (DL) transmission, to one or more receiver devices, e.g., including device 140 and/or device 160.

In some demonstrative aspects, controller 124 may be configured to control, trigger, cause, and/or instruct device 102 to encode a plurality of data packets, for example, a stream of data packets, e.g., including k data packets, into a plurality of encoded packets, for example, a stream of encoded packets, e.g., including n encoded packets, according to an NC scheme, e.g., as described below.

In some demonstrative aspects, controller 124 may be configured to control, trigger, cause, and/or instruct device 102 to transmit k encoded packets of the n encoded packets during a plurality of transmission slots, e.g., DL slots, within an S-TxOP, e.g., as described below.

In some demonstrative aspects, controller 124 may be configured to control, trigger, cause, and/or instruct device 102 to transmit the k encoded packets, for example, by transmitting one or more encoded packets of the k encoded packets during a transmission slot of the plurality of transmission slots within the S-TxOP, e.g., as described below.

In some demonstrative aspects, controller 124 may be configured to control, trigger, cause, and/or instruct device 102 to transmit m other encoded packets of the n encoded packets during one or more subsequent transmission slots within the S-TxOP, for example, based on a determination that m packets of the k encoded packets have not been successfully received, e.g., as described below.

In some demonstrative aspects, controller 154 may be configured to control, trigger, cause, and/or instruct device 140 to communicate the k data packets as part of a transmission, e.g., an Uplink (UL) transmission, to a receiver device, e.g., device 102.

In some demonstrative aspects, controller 154 may be configured to control, trigger, cause, and/or instruct device 140 to encode a plurality of data packets, for example, a stream of data packets, e.g., including k data packets, into a plurality of encoded packets, for example, a stream of encoded packets, e.g., including n encoded packets, according to an NC scheme, e.g., as described below.

In some demonstrative aspects, controller 154 may be configured to control, trigger, cause, and/or instruct device 140 to transmit k encoded packets of the n encoded packets during a plurality of transmission slots, e.g., UL slots, within an S-TxOP, e.g., as described below.

In some demonstrative aspects, controller 154 may be configured to control, trigger, cause, and/or instruct device 140 to transmit the k encoded packets, for example, by transmitting one or more encoded packets of the k encoded packets during a transmission slot of the plurality of transmission slots within the S-TxOP, e.g., as described below.

In some demonstrative aspects, controller 154 may be configured to control, trigger, cause, and/or instruct device 140 to transmit m other encoded packets of the n encoded packets during one or more subsequent transmission slots within the S-TxOP, for example, based on a determination that m packets of the k encoded packets have not been successfully received, e.g., as described below.

In some demonstrative aspects, the count k of packets in the plurality of data packets may be equal to or greater than two, and the count n of encoded packets in the plurality of encoded packets may be greater than k, e.g., as described below.

In some demonstrative aspects, the NC scheme may be configured, for example, such that the k data packets may be decodable from a group of encoded packets including at least k encoded packets of the n encoded packets.

In some demonstrative aspects, the NC scheme may be configured, for example, such that the k data packets may be decodable from any group of p encoded packets from the n encoded packets, wherein p is a predefined value equal to or greater than k.

In some demonstrative aspects, the NC scheme may be configured, for example, such that the k data packets may be decodable from any group of k encoded packets from the n encoded packets.

In some demonstrative aspects, the k data packets may include time-sensitive data packets, e.g., as described below.

In other aspects, the k data packets may include any other additional or alternative type of packets.

In some demonstrative aspects, controller 124 may be configured to control, trigger, cause, and/or instruct device 102 to transmit an Aggregate Medium Access Control Protocol Data Unit (A-MPDU) including the one or more encoded packets during the transmission slot within the S-TxOP, e.g., as described below.

In other aspects, controller 124 may be configured to control, trigger, cause, and/or instruct device 102 to transmit one or more encoded packets in the form of, and/or as part of, any other type of frame and/or transmission.

In some demonstrative aspects, controller 124 may be configured to control, trigger, cause, and/or instruct device 102 to transmit one or more additional other encoded packets of the n encoded packets during one or more additional subsequent transmission slots within the S-TxOP, for example, based on a determination that one or more packets of the m other encoded packets have not been successfully received, e.g., as described below.

In some demonstrative aspects, controller 124 may be configured to control, trigger, cause, and/or instruct device 102 to determine that the one or more encoded packets transmitted during the transmission slot have been successfully received, for example, based on receipt of an Acknowledgement (ACK) during the transmission slot.

In some demonstrative aspects, controller 124 may be configured to control, trigger, cause, and/or instruct device 102 to perform one or more transmissions, for example, until it is determined that a total of k encoded packets have been successfully received, or until a predefined criteria has been met, e.g., as described below.

In some demonstrative aspects, the predefined criteria may include reaching a count of reserved transmission slots for transmission of the k data packets. In other aspects any other additional or alternative criteria may be implemented.

In some demonstrative aspects, controller 124 may be configured to control, trigger, cause, and/or instruct device 102 to perform a transmission including transmitting one or more additional other encoded packets of the n encoded packets during one or more additional subsequent transmission slots within the S-TxOP, for example, based on a determination that one or more encoded packets of a previous transmission have not been successfully received, e.g., as described below.

In some demonstrative aspects, controller 124 may be configured to control, trigger, cause, and/or instruct device 102 to determine a count of reserved transmission slots in the S-TxOP to be reserved for transmission of the k data packets, e.g., as described below.

In some demonstrative aspects, controller 124 may be configured to control, trigger, cause, and/or instruct device 102 to free one or more remaining reserved transmission slots in the S-TxOP, for example, based on a determination that a total of k encoded packets have been successfully received, e.g., as described below.

In some demonstrative aspects, the k data packets may include data packets of a Single User (SU) transmission to a single receiver device, e.g., as described below.

In some demonstrative aspects, the k data packets may include data packets of a SU DL transmission to a single STA, e.g., as described below.

In some demonstrative aspects, controller 124 may be configured to control, trigger, cause, and/or instruct device 102 to communicate the k data packets via one or more SU DL transmissions, which may be addressed to a single STA, e.g., a STA implemented by device 140.

In some demonstrative aspects, controller 124 may be configured to control, trigger, cause, and/or instruct device 102 to determine a count of reserved transmission slots to be reserved for transmission of the k data packets during the S-TxOP, e.g., as described below.

In some demonstrative aspects, the count of reserved transmission slots may be based on a value of n, and on a count of encoded data packets per transmission slot, e.g., as described below.

In some demonstrative aspects, controller 124 may be configured to control, trigger, cause, and/or instruct device 102 to determine the count of reserved transmission slots, for example, based on the ratio n/q, wherein q denotes the count of encoded data packets per transmission slot, e.g., as described below.

In other aspects, the count of reserved transmission slots may be determined based on any other additional or alternative parameter.

In some demonstrative aspects, the k data packets may include data packets of a SU UL transmission from a single STA, for example, to an AP, e.g., as described below.

For example, controller 154 may be configured to control, trigger, cause, and/or instruct device 140 to encode k data packets to be transmitted from device 140, for example, to an AP implemented by device 102, e.g., as described below.

For example, controller 154 may be configured to control, trigger, cause, and/or instruct device 140 to communicate the k data packets via one or more SU UL transmissions, which may be addressed to the AP, e.g., the AP implemented by device 102.

In some demonstrative aspects, controller 154 may be configured to control, trigger, cause, and/or instruct device 140 to determine a count of reserved transmission slots to be reserved for transmission of the k data packets during the S-TxOP, e.g., as described below.

In some demonstrative aspects, the count of reserved transmission slots may be based on a value of n, and on a count of encoded data packets per transmission slot, e.g., as described below.

In some demonstrative aspects, controller 154 may be configured to control, trigger, cause, and/or instruct device 140 to determine the count of reserved transmission slots, for example, based on the ratio n/q, wherein q denotes the count of encoded data packets per transmission slot, e.g., as described below.

In some demonstrative aspects, the k data packets may include data packets of a Multi User (MU) transmission to a plurality of receiver devices, e.g., as described below.

In some demonstrative aspects, the k data packets may include data packets of a MU DL transmission to a plurality of STAs, e.g., as described below.

In some demonstrative aspects, controller 124 may be configured to control, trigger, cause, and/or instruct device 102 to communicate the k data packets via one or more MU DL transmissions, which may be addressed to a plurality of STAs, e.g., including a STA implemented by device 140 and/or a STA implemented by device 160.

In some demonstrative aspects, controller 124 may be configured to control, trigger, cause, and/or instruct device 102 to assign the plurality of transmission slots of the S-TxOP to the plurality of receiver devices, e.g., as described below.

In some demonstrative aspects, controller 124 may be configured to control, trigger, cause, and/or instruct device 102 to assign the plurality of transmission slots of the S-TxOP to the plurality of receiver devices, respectively, for example, by assigning a separate transmission slot to each receiver device, e.g., as described below.

In some demonstrative aspects, controller 124 may be configured to control, trigger, cause, and/or instruct device 102 to determine a count of reserved transmission slots in the S-TxOP to be reserved for transmission of the k data packets to the plurality of receiver devices, e.g., as described below.

In some demonstrative aspects, the count of reserved transmission slots in the S-TxOP may be based, for example, on a count of the plurality of receiver devices, e.g., as described below.

In some demonstrative aspects, controller 124 may be configured to control, trigger, cause, and/or instruct device 102 to transmit the m other encoded packets of the n encoded packets based on a determination that a total of m packets have not been successfully received by one or more of the plurality of receiver devices, e.g., as described below.

In some demonstrative aspects, a wireless communication device, e.g., device 102, device 140 and/or device 160, may be configured to listen over a plurality of transmission slots within an S-TxOP for a plurality of received packets from a transmitter device, e.g., as described below.

In some demonstrative aspects, the plurality of received packets may include at least k encoded packets out of n encoded packets. For example, the n encoded packets may encode k data packets according to an NC scheme, e.g., as described above. For example, k may be equal to or greater than two, and n may be greater than k, e.g., as described above.

In some demonstrative aspects, the wireless communication device, e.g., device 102, device 140 and/or device 160, may be configured to determine the k data packets by decoding the at least k encoded packets according to the NC scheme, e.g., as described below.

In some demonstrative aspects, controller 154 may be configured to control, trigger, cause, and/or instruct device 140 to receive the at least k encoded packets as part of a transmission, e.g., a DL transmission, from a transmitter device, e.g., the DL transmission from device 102.

In some demonstrative aspects, controller 154 may be configured to control, trigger, cause, and/or instruct device 140 to listen over a plurality of transmission slots within an S-TxOP for the plurality of received packets from device 102, e.g., as described below.

In some demonstrative aspects, controller 154 may be configured to control, trigger, cause, and/or instruct device 140 to determine the k data packets by decoding the at least k encoded packets according to the NC scheme, e.g., as described below.

In some demonstrative aspects, controller 124 may be configured to control, trigger, cause, and/or instruct device 102 to receive the at least k encoded packets as part of a transmission, e.g., an UL transmission, from a transmitter device, e.g., the UL transmission from device 140.

In some demonstrative aspects, controller 124 may be configured to control, trigger, cause, and/or instruct device 102 to listen over a plurality of transmission slots within an S-TxOP for the plurality of received packets from device 140, e.g., as described below.

In some demonstrative aspects, controller 124 may be configured to control, trigger, cause, and/or instruct device 102 to determine the k data packets by decoding the at least k encoded packets according to the NC scheme, e.g., as described below.

In some demonstrative aspects, the wireless communication device, e.g., device 102, device 140 and/or device 160, may be configured to process an A-MPDU received during a transmission slot. For example, the A-MPDU may include one or more received packets of the plurality of received packets, e.g., as described below.

In other aspects, the plurality of received packets may be received in the form of, and/or as part of, any other type of frame and/or transmission.

In some demonstrative aspects, the wireless communication device, e.g., device 102, device 140 and/or device 160, may be configured to transmit an ACK during a transmission slot, for example, based on a determination that all encoded packets in the transmission slot have been successfully received, e.g., as described below.

In some demonstrative aspects, the wireless communication device, e.g., device 102, device 140 and/or device 160, may be configured to listen over a predefined count of transmission slots within the S-TxOP for the at least k encoded packets, e.g., as described below.

In some demonstrative aspects, the wireless communication device, e.g., device 102, device 140 and/or device 160, may be configured to listen over one or more subsequent transmission slots within the S-TxOP to receive m other encoded packets of the n encoded packets, for example, based on a determination that m packets of the at least k encoded packets have not been successfully received, e.g., as described below.

In some demonstrative aspects, the wireless communication device, e.g., device 102, device 140 and/or device 160, may be configured to listen over one or more additional subsequent transmission slots within the S-TxOP to receive one or more additional other encoded packets of the n encoded packets, for example, based on a determination that one or more packets of the m other encoded packets have not been successfully received, e.g., as described above.

In some demonstrative aspects, the wireless communication device, e.g., device 102, device 140 and/or device 160, may be configured to perform one or more listening cycles, for example, until it is determined that a total of at least k encoded packets have been successfully received, or until a predefined criteria has been met, e.g., as described below.

In some demonstrative aspects, a listening cycle may include listening over one or more additional subsequent transmission slots within the S-TxOP to receive one or more additional other encoded packets of the n encoded packets, for example, based on a determination that one or more encoded packets of a previous listening cycle have not been successfully received, e.g., as described below.

In some demonstrative aspects, the predefined criteria may include reaching a count of reserved transmission slots for transmission of the k data packets, e.g., as described below.

In other aspects, any other additional or alternative criteria may be implemented.

In some demonstrative aspects, the k data packets may include data packets of a SU transmission to the wireless communication device.

In some demonstrative aspects, the k data packets may include data packets of a SU DL transmission to a single STA, e.g., as described below.

In some demonstrative aspects, controller 154 may be configured to control, trigger, cause, and/or instruct device 140 to receive the k data packets via one or more SU DL transmissions, which may be addressed to a single STA, e.g., a STA implemented by device 140.

In some demonstrative aspects, the k data packets may include data packets of a SU UL transmission from a single STA, e.g., as described below.

In some demonstrative aspects, controller 124 may be configured to control, trigger, cause, and/or instruct device 102 to receive the k data packets via one or more SU UL transmissions, which may be received from a single STA, e.g., a STA implemented by device 140.

In some demonstrative aspects, the wireless communication device, e.g., device 102, device 140 and/or device 160, may be configured to determine a count of reserved transmission slots to be reserved for transmission of the k data packets, e.g., as described below.

In some demonstrative aspects, the count of reserved transmission slots may be based on a value of n, and on a count of encoded data packets per transmission slot, e.g., as described below.

In some demonstrative aspects, the wireless communication device, e.g., device 102, device 140 and/or device 160, may be configured to determine the count of reserved transmission slots, for example, based on the ratio n/q, wherein q denotes the count of encoded data packets per transmission slot, e.g., as described below.

In other aspects, the count of reserved transmission slots may be determined based on any other additional or alternative parameter.

In some demonstrative aspects, the k data packets may include data packets of a MU transmission to a plurality of receiver devices including the wireless communication device.

In some demonstrative aspects, the k data packets may include one or more data packets for the wireless communication device and one or more other data packets for another device, e.g., as described below.

In some demonstrative aspects, controller 154 may be configured to control, trigger, cause, and/or instruct device 140 to receive the k data packets via one or more MU DL transmissions, which may be addressed to a plurality of STAs, e.g., including the STA implemented by device 140.

In some demonstrative aspects, the wireless communication device may be configured to determine a count of reserved transmission slots to be reserved for transmission of the k data packets, e.g., as described below.

In some demonstrative aspects, the count of reserved transmission slots may be based on a count of the plurality of receiver devices in the MU transmission, e.g., as described below.

In some demonstrative aspects, a transmitter device, e.g., device 102, device 140 and/or device 160, may be configured to transmit data packets to a receiver device, for example, as part of a SU transmission, e.g., as described below.

In some demonstrative aspects, the transmitter device may include, for example, an AP device, e.g., an AP implemented by device 102, and/or the receiver device may include, for example, a non-AP STA, e.g., a non-AP STA implemented by device 140 and/or device 160, for example, in case of a DL transmission.

In some demonstrative aspects, the transmitter device may include, for example, a non-AP STA, e.g., implemented by device 140 and/or device 160, and/or the receiver device may include, for example, an AP, e.g., an AP implemented by device 102, for example, in case of an UL transmission.

In some demonstrative aspects, the transmitter device may be configured to generate NC encoded packets, which may be sent and acknowledged using S-TXOP scheduled transmissions, e.g., as described below.

In some demonstrative aspects, the efficient S-TXOP design may be leveraged, for example, to send one or more parity packets of the NC encoded packets, e.g., only the required parity packets, for example, to successfully recover packets in error, e.g., as described below.

In some demonstrative aspects, the transmitter device may be configured to select k packets and encode the k packets using NC, for example, with a code rate k/n, e.g., before sending packets. For example, the transmitter device may generate n encoded packets including (n-k) parity packets, e.g., by encoding the k data packets according to the NC scheme.

In some demonstrative aspects, the transmitter device may be configured to cluster the n encoded packets into one or more PDUs, e.g., one or more A-MPDUs. For example, a PDU, e.g., an A-MPDU, may have a size of [1,n], e.g., including between 1 and n encoded packets per PDU.

In some demonstrative aspects, the transmitter device may be configured to assign the PDUs to a plurality of time slots scheduled in a S-TxOP. In one example, each A-MPDU may be assigned to a respective time slot. In another example, two or more A-MPDUs may be assigned to a same time slot in the S-TXOP.

In some demonstrative aspects, the transmitter device may be configured to assign q<<n packets, e.g., per A-MPDU.

In some demonstrative aspects, the transmitter device may be configured to determine that a same selected Modulation and Coding Scheme (MCS) is to be used for the whole duration of the S-TXOP. In other aspects, two or more different MCS may be used within the same S-TxOP.

In some demonstrative aspects, the transmitter device may be configured to define the S-TXOP to include, for example, at least ┌n/q┐, time slots (reserved time slots) to be assigned (reserved) for transmission of the A-MPDUs carrying the n encoded packets.

In some demonstrative aspects, time slots in the S-TXOP may be configured to include the data packet transmission and a corresponding ACK, e.g., which may be transmitted by the receiver device to acknowledge successful receipt of the packet transmission, e.g., as described above.

In some demonstrative aspects, a retransmission mechanism, e.g., according to an ARQ protocol, may be performed within a time slot, for example, in case a scheduled time of the time slot is long enough, for example, to allow for multiple retransmissions.

In some demonstrative aspects, one or more remaining time slots in the S-TXOP may be freed, for example, to be used for Best Effort (BE) traffic and/or any other traffic, for example, once up to k packets have been transmitted and received free of error. For example, the AP, e.g., the AP implemented by device 102, may schedule BE transmission in the remaining time slots.

In some demonstrative aspects, the transmitter device may transmit additional encoded packets of the n encoded packets, for example, additional parity packets, e.g., if at last some packets have not been received or have been received in error by the receiver device.

In some demonstrative aspects, a receiver device, for example, a non-AP STA, e.g., implemented by device 140 and/or device 160, e.g., in case of a DL transmission, or an AP device, e.g., an AP implemented by device 102, e.g., in case of an UL transmission, may attempt decoding the received packets, for example, for a received parity A-MPDU, e.g., for each received parity A-MPDU.

In some demonstrative aspects, packets in error may be considered as lost packets, for example, once the total number of parity packets have been sent with no success in the NC decoding process.

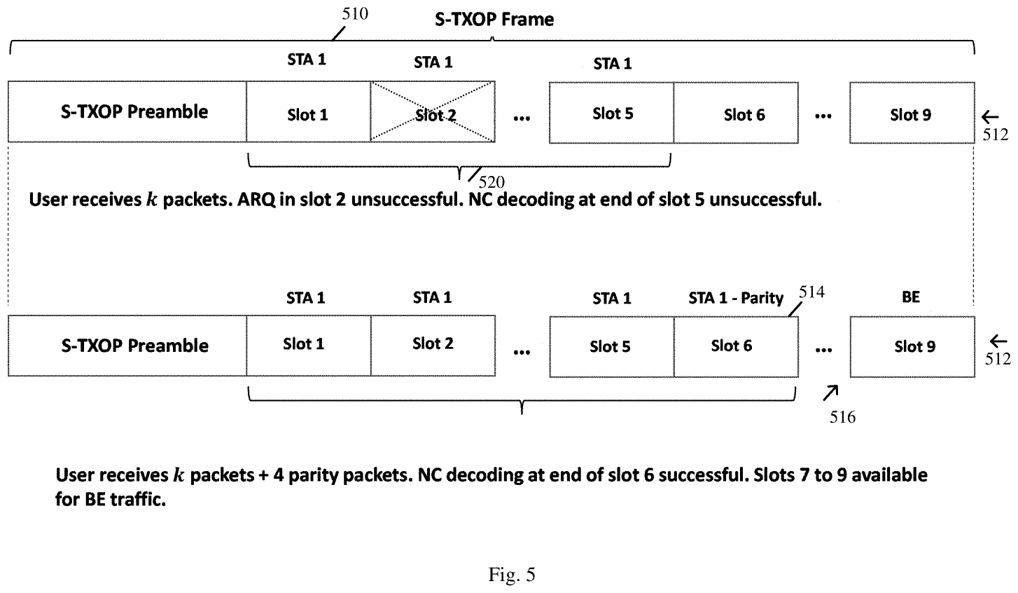

Reference is made to FIG. 5, which schematically illustrates a SU wireless communication according to an NC scheme during an S-TXOP, in accordance with some demonstrative aspects.

In some demonstrative aspects, as shown in FIG. 5, a transmitter device may determine a plurality of time slots 512 to be reserved in an S-TxOP 510 for transmission of encoded packets to a receiver device (STA1) according to an NC scheme.

In some demonstrative aspects, device 102 (FIG. 1) may be configured to perform one or more functionalities and/or operations of the transmitter device, and/or device 140 (FIG. 1) may be configured to perform one or more functionalities and/or operations of the receiver device. In one example, the transmitter device may include, for example, an AP device, e.g., an AP implemented by device 102 (FIG. 1), and/or the receiver device may include, for example, a non-AP STA, e.g., a non-AP STA implemented by device 140 (FIG. 1), for example, in case of a DL transmission.

In some demonstrative aspects, device 140 (FIG. 1) may be configured to perform one or more functionalities and/or operations of the transmitter device, and/or device 102 (FIG. 1) may be configured to perform one or more functionalities and/or operations of the receiver device. In one example, the transmitter device may include, for example, a non-AP STA, e.g., implemented by device 140, and/or the receiver device may include, for example, an AP, e.g., an AP implemented by device 102, for example, in case of an UL transmission.

For example, the transmitter device may encode k=20 data packets into n=36 encoded packets.

For example, as shown in FIG. 5, a total of 36/4=9 timeslots 512 may be scheduled for sending the data packets to the receiver device.

the transmitter device may assign the n=36 encoded packets to 9 timeslots 512 in the S-TxOP 510. For example, q=4 encoded packets may be assigned for transmission per time slot 512. For example, each q=4 encoded packets may be clustered into a respective A-MPDU to be scheduled for transmission in a respective time slot 512.

For example, as shown in FIG. 5, the transmitter device may transmit a first transmission 520 including k=20 encoded packets, which may be transmitted, for example, over 5 time slots 512.

For example, as shown in FIG. 5, an A-MPDU including 4 encoded packets, e.g., the A-MPDU transmitted during the time slot “Slot 2”, may not be successfully received, e.g., may be received with error, at the receiver device.

For example, as shown in FIG. 5, the transmitter may send 4 additional encoded packets, e.g., 4 parity packets, for example, based on a determination that the receiver device has not successfully received the A-MPDU including the 4 encoded packets.

For example, as shown in FIG. 5, the transmitter may send the 4 additional encoded packets in a second transmission, for example, during a time slot (Slot 6) 514, subsequent to the 5 time slots 512 used to transmit the k=20 encoded packets.

For example, as shown in FIG. 5, all transmitted packets may be received free of error from NC decoding at the receiver device, for example, after receiving the additional 4 parity packets.

For example, as shown in FIG. 5, the transmitter device may free the remaining time slots 516, e.g., three remaining time slots (Slot 7, Slot 8, Slot 9) following the time slot 514, for example, based on a determination that the receiver was able to successfully decode the k data packets.

For example, as shown in FIG. 5, the remaining slots 516 may be freed to allow BE traffic transmissions to other stations. For example, the AP may take over and schedule BE transmissions in the remaining time slots 516.

Referring back to FIG. 1, a transmitter device, e.g., device 102, device 140 and/or device 160, may be configured to transmit data packets to a plurality of receiver devices, for example, as part of a MU transmission, for example, according to a multi-user S-TxOP scenario, e.g., as described below.

In some demonstrative aspects, the transmitter device may include, for example, an AP device, e.g., an AP implemented by device 102, and/or the receiver devices may include, for example, non-AP STAs, e.g., a non-AP STA implemented by device 140 and/or a non-AP STA implemented by device 160, for example, in case of an MU DL transmission.

In some demonstrative aspects, a multi-user S-TXOP scheme may be configured to assign a plurality of S-TxOP time slots to a plurality of receiver devices participating in the MU transmission, e.g., as described below.

In some demonstrative aspects, stations involved during the S-TXOP, e.g., all stations, may decode all the packets transmitted by the transmitter device, for example, in order to perform NC decoding, e.g., as described below.

In some demonstrative aspects, additional encoded packets, e.g., parity packets, may be requested, for example, in case a STA, e.g., any STA(s), receive its packet in error, e.g., as described below.

In some demonstrative aspects, a time slot of the S-TxOP, e.g., each time slot, may be assigned to a user, e.g., to a single user. For example, a plurality of time slots in an S-TxOP may be assigned to a respective plurality of users of the MU transmission.

In other aspects, the plurality of S-TxOP time slots may be assigned to the plurality of receiver devices according to any other time-slot-to-user assignment scheme. In one example, two or more time slots may be assigned to a user, e.g., each user. In another example, a first count of time slots may be assigned to a first user, and a second count of time slots, e.g., different from the first count of time slots, may be assigned to a second user.

In some demonstrative aspects, a plurality of k data packets may be transmitted in the MU transmission, for example, the value of k may be based on a total number of users and packets. For example, the value of q may be q=1, e.g., if each time slot is assigned to a single user.

In some demonstrative aspects, the k data packets may be encoded into n encoded packets according to the NC scheme.

In some demonstrative aspects, a total number of n slots may be reserved in the S-TxOP for the MU transmission.

In some demonstrative aspects, a retransmission mechanism, e.g., according to an ARQ protocol, may be performed within a time slot, for example, in case a scheduled time of the time slot is long enough, for example, to allow for multiple retransmissions. For example, for each time slot he ARQ protocol may be performed or may not occur.

In some demonstrative aspects, the transmitter device, e.g., the access point, may receive at the end of a time slot an acknowledgment of the transmission performed in the timeslot.

In some demonstrative aspects, the receiver devices involved in an S-TXOP may be configured to receive, process and/or decode packets sent to other users in different time slots, e.g., in addition to receiving data in their assigned slots.

For example, a receiver participating in the MU transmission may be configured to receive, process and/or decode encoded packets transmitted during the time slot assigned to the receiver device, as well as encoded packets in other, e.g., all other, time slots, which may be assigned to other receiver devices.

In some demonstrative aspects, after k time slots have occurred, the transmitter device may check if any user has a packet failure, e.g., based on the ACKs received from the receiver devices during the time slots.

In some demonstrative aspects, the transmitter device may be configured to proceed to send additional encoded packets, e.g., parity packets, if needed, for example, in case the transmitter device determines that one or more users have not successfully received one or more of the encoded packets transmitted during the previous transmission.

In some demonstrative aspects, the NC scheme may be used by a receiver device to decode packets in error, for example, for each parity packet.

In some demonstrative aspects, NC decoding may be stopped, for example, if the NC decoding is determined to be successful, or if no additional parity packets are available, in which case packets in error may be considered lost.

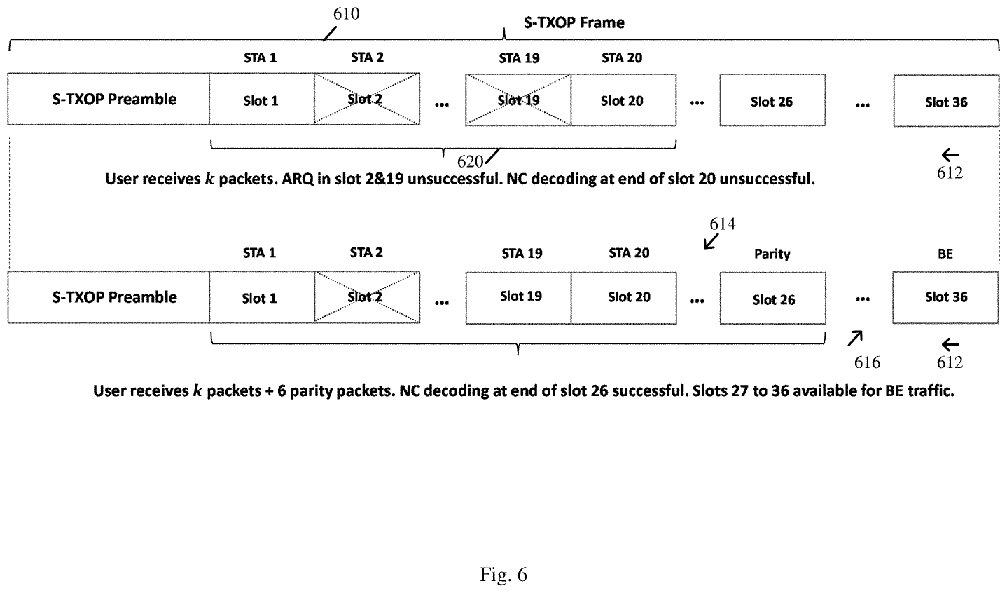

Reference is made to FIG. 6, which schematically illustrates an MU wireless communication according to an NC scheme during an S-TXOP, in accordance with some demonstrative aspects.

In some demonstrative aspects, as shown in FIG. 6, a transmitter device may determine a plurality of time slots 612 to be reserved in an S-TxOP 610 for transmission of encoded packets to a plurality of stations, e.g., including 20 stations (STA1 . . . STA20) according to an NC scheme.

In some demonstrative aspects, device 102 (FIG. 1) may be configured to perform one or more functionalities and/or operations of the transmitter device, and/or device 140 (FIG. 1) and/or device 160 (FIG. 1) may be configured to perform one or more functionalities and/or operations of the receiver devices. In one example, the transmitter device may include, for example, an AP device, e.g., an AP implemented by device 102 (FIG. 1), and/or the receiver devices may include, for example, non-AP STAs, e.g., a non-AP STA implemented by device 140 (FIG. 1) and/or a non-AP STA implemented by device 160 (FIG. 1), for example, in case of a MU DL transmission.

For example, the transmitter device may encode a total k=20 data packets into n=36 encoded packets.

For example, as shown in FIG. 6, a total of 36/1=36 timeslots 612 may be scheduled for sending the data packets to the 20 receiver devices, for example, in case q=1.

For example, as shown in FIG. 6, the transmitter device may assign the n=36 encoded packets to the 20 timeslots 612 in the S-TxOP 610.

For example, as shown in FIG. 6, the transmitter device may transmit a first transmission 620 including k=20 encoded packets, which may be transmitted, for example, over 20 time slots 612.

For example, as shown in FIG. 6, a transmission of encoded packets transmitted during the time slot “Slot 2”, e.g., assigned to the STA 2, and a transmission of encoded packets transmitted during the time slot “Slot 19”, e.g., assigned to the STA 19, may not be successfully received, e.g., may be received with error, at the receiver devices.

For example, as shown in FIG. 6, the transmitter device may determine that the NC decoding at the end of Slot 20 is unsuccessful, e.g., based on unsuccessful ARQ in Slot 2 and Slot 19.

For example, as shown in FIG. 6, the transmitter device may send one or more additional transmissions including additional encoded packets, for example, based on a determination that the receiver devices has not successfully received the encoded packets in the Slot 2 and the Slot 19.

For example, as shown in FIG. 6, the NC coding may be determined to be successful for all receiver devices, for example, after 6 additional encoded packets, e.g., 6 parity packets, have been sent during 6 additional time slots 614, e.g., Slot 21-Slot 26.

For example, as shown in FIG. 6, the transmitter device may free the remaining time slots 616, e.g., three remaining time slots (Slot 27-Slot 36), for example, based on a determination that all user STAs were able to successfully decode the k data packets.

For example, as shown in FIG. 6, the remaining slots 616 may be freed to allow BE traffic transmissions to other stations. For example, the AP may take over and schedule BE transmissions in the remaining time slots 616.

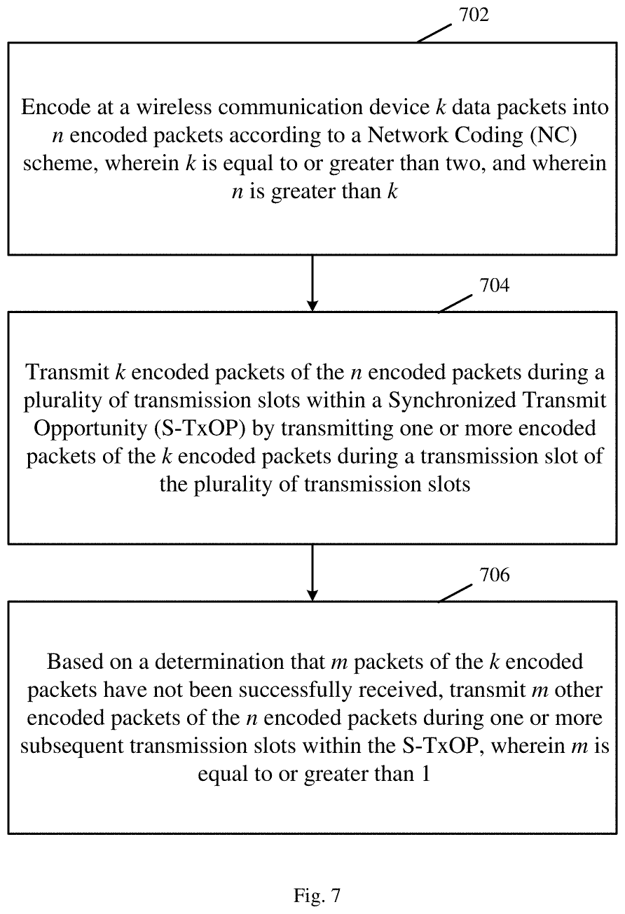

Reference is made to FIG. 7, which schematically illustrates a method of wireless communication based on an NC scheme, in accordance with some demonstrative aspects. For example, one or more of the operations of the method of FIG. 7 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 702, the method may include encoding at a wireless communication device k data packets into n encoded packets according to an NC scheme. In one example, controller 124 (FIG. 1) may be configured to cause, trigger, and/or control device 102 (FIG. 1) to encode the k data packets into the n encoded packets according to the NC scheme, e.g., as described above. In another example, controller 154 (FIG. 1) may be configured to cause, trigger, and/or control device 140 (FIG. 1) to encode the k data packets into the n encoded packets according to the NC scheme, e.g., as described above.

As indicated at block 704, the method may include transmitting k encoded packets of the n encoded packets during a plurality of transmission slots within an S-TxOP, for example, by transmitting one or more encoded packets of the k encoded packets during a transmission slot of the plurality of transmission slots. In one example, controller 124 (FIG. 1) may be configured to cause, trigger, and/or control device 102 (FIG. 1) to transmit the k encoded packets during the plurality of transmission slots within the S-TxOP, e.g., as described above. In one example, controller 154 (FIG. 1) may be configured to cause, trigger, and/or control device 140 (FIG. 1) to transmit the k encoded packets during the plurality of transmission slots within the S-TxOP, e.g., as described above.

As indicated at block 706, the method may include transmitting m other encoded packets of the n encoded packets during one or more subsequent transmission slots within the S-TxOP, for example, based on a determination that m packets of the k encoded packets have not been successfully received. In one example, controller 124 (FIG. 1) may be configured to cause, trigger, and/or control device 102 (FIG. 1) to transmit the m other encoded packets of the n encoded packets during the one or more subsequent transmission slots within the S-TxOP, e.g., as described above. In one example, controller 154 (FIG. 1) may be configured to cause, trigger, and/or control device 140 (FIG. 1) to transmit the m other encoded packets of the n encoded packets during the one or more subsequent transmission slots within the S-TxOP, e.g., as described above.

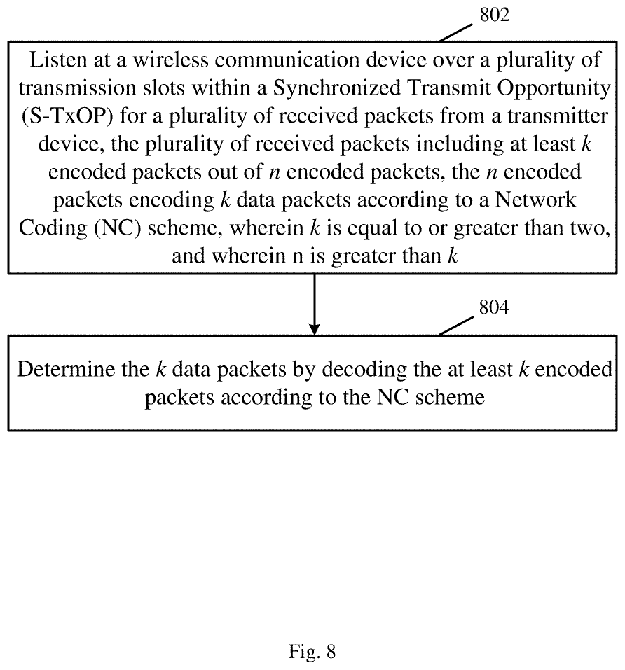

Reference is made to FIG. 8, which schematically illustrates a method of wireless communication based on an NC scheme, in accordance with some demonstrative aspects. For example, one or more of the operations of the method of FIG. 8 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 802, the method may include listening at a wireless communication device over a plurality of transmission slots within an S-TxOP for a plurality of received packets from a transmitter device. For example, the plurality of received packets may include at least k encoded packets out of n encoded packets. For example, the n encoded packets may encode k data packets according to an NC scheme, wherein k is equal to or greater than two, and wherein n is greater than k. In one example, controller 154 (FIG. 1) may be configured to cause, trigger, and/or control device 140 (FIG. 1) to listen over the plurality of transmission slots within the S-TxOP for a plurality of received packets transmitted by device 102 (FIG. 1), e.g., as described above. In another example, controller 124 (FIG. 1) may be configured to cause, trigger, and/or control device 102 (FIG. 1) to listen over the plurality of transmission slots within the S-TxOP for a plurality of received packets transmitted by device 140 (FIG. 1), e.g., as described above.

As indicated at block 804, the method may include determining the k data packets, for example, by decoding the at least k encoded packets according to the NC scheme. In one example, controller 154 (FIG. 1) may be configured to cause, trigger, and/or control device 140 (FIG. 1) to determine the k data packets, for example, by decoding the at least k encoded packets according to the NC scheme, e.g., as described above. In another example, controller 124 (FIG. 1) may be configured to cause, trigger, and/or control device 102 (FIG. 1) to determine the k data packets, for example, by decoding the at least k encoded packets according to the NC scheme, e.g., as described above.

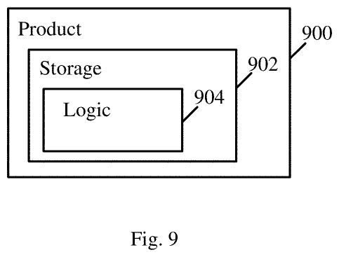

Reference is made to FIG. 9, which schematically illustrates a product of manufacture 900, in accordance with some demonstrative aspects. Product 900 may include one or more tangible computer-readable (“machine-readable”) non-transitory storage media 902, which may include computer-executable instructions, e.g., implemented by logic 904, operable to, when executed by at least one computer processor, enable the at least one computer processor to implement one or more operations at device 102 (FIG. 1), device 140 (FIG. 1), device 160 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1); to cause device 102 (FIG. 1), device 140 (FIG. 1), device 160 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1) to perform, trigger and/or implement one or more operations and/or functionalities; and/or to perform, trigger and/or implement one or more operations and/or functionalities described with reference to the FIGS. 1-8, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 900 and/or machine readable storage media 902 may include one or more types of computer-readable storage media capable of storing data, including volatile memory, non-volatile memory, removable or non-removable memory, erasable or non-erasable memory, writeable or re-writeable memory, and the like. For example, machine readable storage media 902 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a hard drive, an optical disk, a magnetic disk, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 904 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 904 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes an apparatus comprising logic and circuitry configured to cause a wireless communication device to encode k data packets into n encoded packets according to a Network Coding (NC) scheme, wherein k is equal to or greater than two, and wherein n is greater than k; transmit k encoded packets of the n encoded packets during a plurality of transmission slots within a Synchronized Transmit Opportunity (S-TxOP) by transmitting one or more encoded packets of the k encoded packets during a transmission slot of the plurality of transmission slots; and based on a determination that m packets of the k encoded packets have not been successfully received, transmit m other encoded packets of the n encoded packets during one or more subsequent transmission slots within the S-TxOP, wherein m is equal to or greater than 1.

Example 2 includes the subject matter of Example 1, and optionally, wherein the apparatus is configured to cause the wireless communication device to, based on a determination that one or more packets of the m other encoded packets have not been successfully received, transmit one or more additional other encoded packets of the n encoded packets during one or more additional subsequent transmission slots within the S-TxOP.

Example 3 includes the subject matter of Example 1 or 2, and optionally, wherein the apparatus is configured to cause the wireless communication device to perform one or more transmissions until it is determined that a total of k encoded packets have been successfully received or until a predefined criteria has been met, wherein a transmission comprises based on a determination that one or more encoded packets of a previous transmission have not been successfully received, transmitting one or more additional other encoded packets of the n encoded packets during one or more additional subsequent transmission slots within the S-TxOP.

Example 4 includes the subject matter of Example 3, and optionally, wherein the predefined criteria comprises reaching a count of reserved transmission slots for transmission of the k data packets.

Example 5 includes the subject matter of any one of Examples 1-4, and optionally, wherein the k data packets comprise data packets of a Single User (SU) transmission to a single receiver device.

Example 6 includes the subject matter of Example 5, and optionally, wherein the apparatus is configured to cause the wireless communication device to determine a count of reserved transmission slots to be reserved for transmission of the k data packets, wherein the count of reserved transmission slots is based on a value of n, and on a count of encoded data packets per transmission slot.

Example 7 includes the subject matter of Example 6, and optionally, wherein the apparatus is configured to cause the wireless communication device to determine the count of reserved transmission slots based on the ratio n/q, wherein q denotes the count of encoded data packets per transmission slot.

Example 8 includes the subject matter of any one of Examples 1-4, and optionally, wherein the k data packets comprise data packets of a Multi User (MU) transmission to a plurality of receiver devices.

Example 9 includes the subject matter of Example 8, and optionally, wherein the apparatus is configured to cause the wireless communication device to transmit the m other encoded packets of the n encoded packets based on a determination that a total of m packets have not been successfully received by one or more of the plurality of receiver devices.

Example 10 includes the subject matter of Example 8 or 9, and optionally, wherein the apparatus is configured to cause the wireless communication device to assign the plurality of transmission slots to the plurality of receiver devices, respectively.

Example 11 includes the subject matter of any one of Examples 8-10, and optionally, wherein the apparatus is configured to cause the wireless communication device to determine a count of reserved transmission slots to be reserved for transmission of the k data packets, wherein the count of reserved transmission slots is based on a count of the plurality of receiver devices.

Example 12 includes the subject matter of any one of Examples 1-11, and optionally, wherein the apparatus is configured to cause the wireless communication device to transmit an Aggregate Medium Access Control Protocol Data Unit (A-MPDU) comprising the one or more encoded packets during the transmission slot.

Example 13 includes the subject matter of any one of Examples 1-12, and optionally, wherein the apparatus is configured to cause the wireless communication device to determine that the one or more encoded packets transmitted during the transmission slot have been successfully received based on receipt of an Acknowledgement (ACK) during the transmission slot.

Example 14 includes the subject matter of any one of Examples 1-13, and optionally, wherein the apparatus is configured to cause the wireless communication device to determine a count of reserved transmission slots to be reserved for transmission of the k data packets, and to free one or more remaining reserved transmission slots based on a determination that a total of k encoded packets have been successfully received.

Example 15 includes the subject matter of any one of Examples 1-14, and optionally, wherein the NC coding scheme is configured such that the k data packets are decodable from any group of p encoded packets from the n encoded packets, wherein p is a predefined value equal to or greater than k.

Example 16 includes the subject matter of any one of Examples 1-15, and optionally, wherein the NC coding scheme is configured such that the k data packets are decodable from any group of k encoded packets from the n encoded packets.

Example 17 includes the subject matter of any one of Examples 1-16, and optionally, wherein the k data packets comprise time-sensitive data packets.

Example 18 includes the subject matter of any one of Examples 1-17, and optionally, comprising at least one radio to transmit the k encoded packets.

Example 19 includes the subject matter of Example 18, and optionally, comprising one or more antennas connected to the radio, and a processor to execute instructions of an operating system of the wireless communication device.

Example 20 includes an apparatus comprising logic and circuitry configured to cause a wireless communication device to listen over a plurality of transmission slots within a Synchronized Transmit Opportunity (S-TxOP) for a plurality of received packets from a transmitter device, the plurality of received packets comprising at least k encoded packets out of n encoded packets, the n encoded packets encoding k data packets according to a Network Coding (NC) scheme, wherein k is equal to or greater than two, and wherein n is greater than k; and determine the k data packets by decoding the at least k encoded packets according to the NC scheme.

Example 21 includes the subject matter of Example 20, and optionally, wherein the apparatus is configured to cause the wireless communication device to listen over a predefined count of transmission slots within the S-TxOP for the at least k encoded packets; and based on a determination that m packets of the at least k encoded packets have not been successfully received, listen over one or more subsequent transmission slots within the S-TxOP to receive m other encoded packets of the n encoded packets.

Example 22 includes the subject matter of Example 21, and optionally, wherein the apparatus is configured to cause the wireless communication device to, based on a determination that one or more packets of the m other encoded packets have not been successfully received, listen over one or more additional subsequent transmission slots within the S-TxOP to receive one or more additional other encoded packets of the n encoded packets.

Example 23 includes the subject matter of any one of Examples 20-22, and optionally, wherein the apparatus is configured to cause the wireless communication device to perform one or more listening cycles until it is determined that a total of at least k encoded packets have been successfully received or until a predefined criteria has been met, wherein a listening cycle comprises based on a determination that one or more encoded packets of a previous listening cycle have not been successfully received, listening over one or more additional subsequent transmission slots within the S-TxOP to receive one or more additional other encoded packets of the n encoded packets.

Example 24 includes the subject matter of Example 23, and optionally, wherein the predefined criteria comprises reaching a count of reserved transmission slots for transmission of the k data packets.

Example 25 includes the subject matter of any one of Examples 20-24, and optionally, wherein the k data packets comprise data packets of a Single User (SU) transmission to the wireless communication device.

Example 26 includes the subject matter of Example 25, and optionally, wherein the apparatus is configured to cause the wireless communication device to determine a count of reserved transmission slots to be reserved for transmission of the k data packets, wherein the count of reserved transmission slots is based on a value of n, and on a count of encoded data packets per transmission slot.

Example 27 includes the subject matter of Example 26, and optionally, wherein the apparatus is configured to cause the wireless communication device to determine the count of reserved transmission slots based on the ratio n/q, wherein q denotes the count of encoded data packets per transmission slot.

Example 28 includes the subject matter of any one of Examples 20-24, and optionally, wherein the k data packets comprise data packets of a Multi User (MU) transmission to a plurality of receiver devices, the plurality of receiver devices comprising the wireless communication device, wherein the k data packets comprise one or more data packets for the wireless communication device.

Example 29 includes the subject matter of Example 28, and optionally, wherein the apparatus is configured to cause the wireless communication device to determine a count of reserved transmission slots to be reserved for transmission of the k data packets, wherein the count of reserved transmission slots is based on a count of the plurality of receiver devices.

Example 30 includes the subject matter of any one of Examples 20-29, and optionally, wherein the apparatus is configured to cause the wireless communication device to process an Aggregate Medium Access Control Protocol Data Unit (A-MPDU) received during a transmission slot, the A-MPDU comprising one or more received packets.

Example 31 includes the subject matter of any one of Examples 20-30, and optionally, wherein the apparatus is configured to cause the wireless communication device to transmit an Acknowledgement (ACK) during a transmission slot, based on a determination that all encoded packets in the transmission slot have been successfully received.

Example 32 includes the subject matter of any one of Examples 20-31, and optionally, wherein the NC coding scheme is configured such that the k data packets are decodable from any group of p encoded packets from the n encoded packets, wherein p is a predefined value equal to or greater than k.

Example 33 includes the subject matter of any one of Examples 20-32, and optionally, wherein the NC coding scheme is configured such that the k data packets are decodable from any group of k encoded packets from the n encoded packets.

Example 34 includes the subject matter of any one of Examples 20-33, and optionally, wherein the k data packets comprise time-sensitive data packets.

Example 35 includes the subject matter of any one of Examples 20-34, and optionally, comprising at least one radio to receive the plurality of received packets.

Example 36 includes the subject matter of Example 35, and optionally, comprising one or more antennas connected to the radio, and a processor to execute instructions of an operating system of the wireless communication device.

Example 37 comprises a wireless communication device comprising the apparatus of any of Examples 1-36.

Example 38 comprises an apparatus comprising means for executing any of the described operations of any of Examples 1-36.

Example 39 comprises a product comprising one or more tangible computer-readable non-transitory storage media comprising computer-executable instructions operable to, when executed by at least one processor, enable the at least one processor to cause a wireless communication device to perform any of the described operations of any of Examples 1-36.

Example 40 comprises an apparatus comprising: a memory interface; and processing circuitry configured to: perform any of the described operations of any of Examples 1-36.

Example 41 comprises a method comprising any of the described operations of any of Examples 1-36.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising logic and circuitry configured to cause a wireless communication device to:
encode k data packets into n encoded packets according to a Network Coding (NC) scheme, wherein k is equal to or greater than two, and wherein n is greater than k;
transmit k encoded packets of the n encoded packets during a plurality of transmission slots within a Synchronized Transmit Opportunity (S-TxOP) by transmitting one or more encoded packets of the k encoded packets during a transmission slot of the plurality of transmission slots; and
based on a determination that m packets of the k encoded packets have not been successfully received, transmit m other encoded packets of the n encoded packets during one or more subsequent transmission slots within the S-TxOP, wherein m is equal to or greater than 1.

2. The apparatus of claim 1 configured to cause the wireless communication device to, based on a determination that one or more packets of the m other encoded packets have not been successfully received, transmit one or more additional other encoded packets of the n encoded packets during one or more additional subsequent transmission slots within the S-TxOP.

3. The apparatus of claim 1 configured to cause the wireless communication device to perform one or more transmissions until it is determined that a total of k encoded packets have been successfully received or until a predefined criteria has been met, wherein a transmission comprises:
based on a determination that one or more encoded packets of a previous transmission have not been successfully received, transmitting one or more additional other encoded packets of the n encoded packets during one or more additional subsequent transmission slots within the S-TxOP.

4. The apparatus of claim 3, wherein the predefined criteria comprises reaching a count of reserved transmission slots for transmission of the k data packets.

5. The apparatus of claim 1, wherein the k data packets comprise data packets of a Single User (SU) transmission to a single receiver device.

6. The apparatus of claim 5 configured to cause the wireless communication device to determine a count of reserved transmission slots to be reserved for transmission of the k data packets, wherein the count of reserved transmission slots is based on a value of n, and on a count of encoded data packets per transmission slot.

7. The apparatus of claim 6 configured to cause the wireless communication device to determine the count of reserved transmission slots based on the ratio n/q, wherein q denotes the count of encoded data packets per transmission slot.

8. The apparatus of claim 1, wherein the k data packets comprise data packets of a Multi User (MU) transmission to a plurality of receiver devices.

9. The apparatus of claim 8 configured to cause the wireless communication device to transmit the m other encoded packets of the n encoded packets based on a determination that a total of m packets have not been successfully received by one or more of the plurality of receiver devices.

10. The apparatus of claim 8 configured to cause the wireless communication device to assign the plurality of transmission slots to the plurality of receiver devices, respectively.

11. The apparatus of claim 8 configured to cause the wireless communication device to determine a count of reserved transmission slots to be reserved for transmission of the k data packets, wherein the count of reserved transmission slots is based on a count of the plurality of receiver devices.

12. The apparatus of claim 1 configured to cause the wireless communication device to transmit an Aggregate Medium Access Control Protocol Data Unit (A-MPDU) comprising the one or more encoded packets during the transmission slot.

13. The apparatus of claim 1 configured to cause the wireless communication device to determine that the one or more encoded packets transmitted during the transmission slot have been successfully received based on receipt of an Acknowledgement (ACK) during the transmission slot.

14. The apparatus of claim 1 configured to cause the wireless communication device to determine a count of reserved transmission slots to be reserved for transmission of the k data packets, and to free one or more remaining reserved transmission slots based on a determination that a total of k encoded packets have been successfully received.

15. The apparatus of claim 1, wherein the NC coding scheme is configured such that the k data packets are decodable from any group of p encoded packets from the n encoded packets, wherein p is a predefined value equal to or greater than k.

16. The apparatus of claim 1, wherein the NC coding scheme is configured such that the k data packets are decodable from any group of k encoded packets from the n encoded packets.

17. The apparatus of claim 1, wherein the k data packets comprise time-sensitive data packets.

18. The apparatus of claim 1 comprising at least one radio to transmit the k encoded packets.

19. The apparatus of claim 18 comprising one or more antennas connected to the radio, and a processor to execute instructions of an operating system of the wireless communication device.

20. A product comprising one or more tangible computer-readable non-transitory storage media comprising computer-executable instructions operable to, when executed by at least one processor, enable the at least one processor to cause a wireless communication device to:
encode k data packets into n encoded packets according to a Network Coding (NC) scheme, wherein k is equal to or greater than two, and wherein n is greater than k;
transmit k encoded packets of the n encoded packets during a plurality of transmission slots within a Synchronized Transmit Opportunity (S-TxOP) by transmitting one or more encoded packets of the k encoded packets during a transmission slot of the plurality of transmission slots; and
based on a determination that m packets of the k encoded packets have not been successfully received, transmit m other encoded packets of the n encoded packets during one or more subsequent transmission slots within the S-TxOP, wherein m is equal to or greater than 1.

21. The product of claim 20, wherein the instructions, when executed, cause the wireless communication device to, based on a determination that one or more packets of the m other encoded packets have not been successfully received, transmit one or more additional other encoded packets of the n encoded packets during one or more additional subsequent transmission slots within the S-TxOP.

22. An apparatus comprising logic and circuitry configured to cause a wireless communication device to:
listen over a plurality of transmission slots within a Synchronized Transmit Opportunity (S-TxOP) for a plurality of received packets from a transmitter device, the plurality of received packets comprising at least k encoded packets out of n encoded packets, the n encoded packets encoding k data packets according to a Network Coding (NC) scheme, wherein k is equal to or greater than two, and wherein n is greater than k; and
determine the k data packets by decoding the at least k encoded packets according to the NC scheme.

23. The apparatus of claim 22 configured to cause the wireless communication device to:
listen over a predefined count of transmission slots within the S-TxOP for the at least k encoded packets; and
based on a determination that m packets of the at least k encoded packets have not been successfully received, listen over one or more subsequent transmission slots within the S-TxOP to receive m other encoded packets of the n encoded packets.

24. The apparatus of claim 22 configured to cause the wireless communication device to perform one or more listening cycles until it is determined that a total of at least k encoded packets have been successfully received or until a predefined criteria has been met, wherein a listening cycle comprises:
based on a determination that one or more encoded packets of a previous listening cycle have not been successfully received, listening over one or more additional subsequent transmission slots within the S-TxOP to receive one or more additional other encoded packets of the n encoded packets.

25. The apparatus of claim 22 configured to cause the wireless communication device to transmit an Acknowledgement (ACK) during a transmission slot, based on a determination that all encoded packets in the transmission slot have been successfully received.
